(19) United States
(12) Patent Application Publication
(10) Pub. No.: US 2015/0290079 A1
(43) Pub. Date: Oct. 15, 2015

(54) DRUG CONTAINER STORAGE DEVICE, DRUG CONTAINER STORAGE SYSTEM, AND METHOD FOR SUCKING DRUG

(71) Applicants: OTSUKA TECHNO CORPORATION, Naruto-shi, Tokushima (JP); OTSUKA PHARMACEUTICAL FACTORY, INC., Naruto-shi, Tokushima (JP)

(72) Inventors: Masaki Nishioka, Naka-gun (JP); Osamu Takiguchi, Naka-gun (JP); Katsuyoshi Hamai, Naka-gun (JP); Tetsuya Masuda, Naka-gun (JP); Fujio Inoue, Naruto-shi (JP); Takashi Yoshinari, Naruto-shi (JP)

(73) Assignees: OTSUKA TECHNO CORPORATION, Naruto-shi, Tokushima (JP); OTSUKA PHARMACEUTICAL FACTORY, INC., Naruto-shi, Tokushima (JP)

(21) Appl. No.: 14/437,614

(22) PCT Filed: Oct. 2, 2013
(86) PCT No.: PCT/JP2013/076803

§ 371 Date: Apr. 22, 2015

(30) Foreign Application Priority Data
Nov. 1, 2012 (JP) 2012-242039
Apr. 22, 2013 (JP) 2013-089423

(51) Int. Cl. A61J 1/14; A61J 1/20

(52) U.S. Cl. CPC A61J 1/1406; A61J 1/2096; A61J 1/1418; A61J 1/1487; A61J 1/201

(57) ABSTRACT

There is provided a drug container storage device used for performing sucking of a drug contained in a drug container using a syringe, the syringe having a passage portion through which a liquid is sucked in and discharged, and the drug container having a lid portion that can be penetrated by the passage portion. The drug container storage device has a main body portion including a closed space configured to accommodate the drug container and a first opening; and an elastic sealing portion configured to hermetically seal the first opening of the main body portion and that can be penetrated by the passage portion of the syringe. The main body portion is configured to accommodate the drug container such that a space is formed between the lid portion of the accommodated drug container and the elastic sealing portion.

### TECHNICAL FIELD

The present invention relates to a drug container storage device, a drug container storage system, and a method for sucking a drug.

### BACKGROUND ART

Conventionally, health damage to medical personnel who handle cytotoxic drugs, which may be used in chemotherapy etc., has been regarded as a problem. Cytotoxic drugs are usually distributed in a state in which the drugs are sealed in containers. Medical personnel are required to dissolve, take out, dilute, or mix the drugs in such containers using syringes. During such operations, the drugs may leak or vaporize, and not a few incidents of exposure to the drugs have occurred.

To avoid such incidents, medical personnel perform the operations within devices such as isolators and safety cabinets while wearing caps, masks, gowns, gloves, etc., or use special instruments disclosed in Patent Literature 1 and Patent Literature 2. The special instruments disclosed in Patent Literature 1 and Patent Literature 2 are instruments that connect a drug container to a syringe for extracting a drug from the drug container, and suppress exposure of the surrounding environments to the drug that has leaked during extraction of the drug into the syringe.

### CITATION LIST

### Patent Literature

Patent Literature 1: JP-T 2009-514641

Patent Literature 2: JP-T 2005-504609

### SUMMARY OF INVENTION

### Technical Problem

With the above-described instruments, even though an opening portion of the drug container is closed, the drug container itself is still exposed to the outside, and if the drug leaks through the opening portion, a person who touches the instrument may be exposed to the drug. Moreover, even after disposal of the drug container, the drug may be exposed, and this may pose a serious environmental problem.

An object of the present invention is to provide a drug container storage device, a drug container storage system, a method for sucking a drug, and a method for mixing a drug that make it possible that, during sucking of a drug contained in a drug container using a syringe, the syringe having a passage portion through which a liquid is sucked in and discharged, and the drug container having a lid portion into which the passage portion can be stabbed, even if the drug leaks or vaporizes from the drug container, exposure is prevented from extending to the outside.

### Solution to Problem

A drug container storage device according to the present invention is a drug container storage device used for performing sucking of a drug contained in a drug container using a syringe, the syringe having a passage portion through which a liquid is sucked in and discharged, and the drug container having a lid portion that can be penetrated by the passage portion, the drug container storage device including a main body portion having a closed space configured to accommodate the drug container and a first opening, and an elastic sealing portion configured to hermetically seal the first opening of the main body portion and that can be penetrated by the passage portion of the syringe, wherein the main body portion is configured to accommodate the drug container such that a space is formed between the lid portion of the accommodated drug container and the elastic sealing portion.

With this configuration, the drug container can be accommodated in the closed space that is hermetically sealed, and furthermore, the drug container is accommodated such that a space is formed between the lid portion of the drug container that is accommodated in the main body portion and the elastic sealing portion that hermetically seals the first opening of the main body portion. Therefore, during withdrawal of the passage portion of the syringe after passing the passage portion through the elastic sealing portion and the lid portion and sucking the drug into the syringe, even if the drug leaks from the drug container, the drug that has leaked drops into the space between the lid portion and the elastic sealing portion, and thus the drug can be kept in the closed space. As a result, during sucking of the drug into the syringe, exposure of the drug can be prevented from extending to the outside of the elastic sealing portion. In addition, since the drug container is hermetically sealed in the drug container storage device, the drug container can be disposed without exposing the drug to the outside by simply disposing of the drug container storage device as is. Accordingly, even after disposal, exposure of the drug from the drug container to the outside can be prevented.

In the above-described drug container storage device, it is possible that the main body portion is provided with a second opening through which the drug container is accommodated and a closing portion configured to hermetically seal the second opening. The closing portion can be attached to any portion of the main body portion. For example, the closing portion may be provided on an outer circumferential surface of the main body portion, and may also be provided at a position in which the closing portion opposes the first opening. Moreover, the first opening may be provided in the closing portion.

In the above-described drug container storage device, it is possible that the first and second openings are formed opposing each other, and the closing portion is configured so as to press the drug container toward the side of the first opening and fix the drug container in the main body portion.

This configuration makes it possible to fix the drug container in the drug container by inserting the drug container into the closed space through the second opening and closing the closing portion. Accordingly, hermetic sealing of the closed space and fixation of the drug container can be performed at the same time.

In the above-described drug container storage device, it is possible that on a first opposing surface, of at least one of the main body portion and the elastic sealing portion, that is configured to oppose a top surface of the lid portion of the drug container, a protruding portion configured to secure the space between the top surface of the lid portion and the elastic sealing portion is formed.

Here, due to the presence of the protruding portion that is formed on the first opposing surface, a certain distance is kept between the first opposing surface and the top surface of the lid portion of the drug container, and a space for accommodating the drug leaking from the drug container is secured between the top surface of the lid portion and the elastic sealing portion. Accordingly, the space that is capable of accommodating the drug leaking from the drug container can be secured between the lid portion of the drug container and the elastic sealing portion with a simple structure.

In the above-described drug container storage device, it is possible that a protruding portion is formed on a second opposing surface, of at least one of the main body portion and the elastic sealing portion, that is configured to oppose a side surface of the lid portion of the drug container.

Here, due to the presence of the protruding portion that is formed on the second opposing surface, a certain distance is kept between the second opposing surface and the side surface of the lid portion of the drug container, and a space for allowing the drug that has dropped into the space between the top surface of the lid portion and the elastic sealing portion to move to a lower end of the lid portion is secured between the second opposing surface and the side surface of the lid portion. Accordingly, the drug leaking from the drug container can be caused to move away from the first opening, and leakage of the drug through the first opening can be reliably prevented. In particular, in cases where a large amount of drug has leaked from the drug container, this plays a significant role in preventing exposure of the drug.

In the above-described drug container storage device, it is possible that the main body portion is a deformable bag. Thus, the main body portion here can accommodate drug containers of various sizes and shapes. Accordingly, this drug container storage device can deal with drug containers of various sizes and shapes.

In the above-described drug container storage device, it is possible that the main body portion is configured so as to include a tubular drum portion having, at opposite end portions, a first end portion in which the second opening is formed and a second end portion, a shoulder portion having a sloped surface that is sloped from the first end portion in a funnel shape, and a neck portion that is continuous with the shoulder portion and in which the first opening is formed, wherein the space is formed by bringing the lid portion of the drug container into contact with the sloped surface of the shoulder portion.

With this configuration, since the shoulder portion of the main body portion is formed into a funnel shape having the sloped surface, when the drug container is inserted into the main body portion, the lid portion of the drug container comes into contact with the sloped surface. Thus, irrespective of the shape of the drug container, the drug container can be positioned relative to the main body portion, and furthermore, the space between the lid portion of the drug container and the elastic sealing portion can also be formed. Accordingly, positioning of the drug container relative to the main body portion can be readily performed with a simple structure.

In the above-described drug container storage device, it is possible that a plurality of grooves or ribs are formed on the sloped surface, the grooves or ribs extending from the first opening toward the drum portion. Since the plurality of grooves or ribs extending from the first opening toward the drum portion are formed on the sloped surface in this manner, the drug that has dropped into the space between the lid portion and the elastic sealing portion can be caused to move along the grooves or ribs toward the drum portion. Accordingly, the drug leaking from the drug container can be caused to move away from the first opening, and thus leakage of the drug through the first opening can be reliably prevented. In particular, in cases where a large amount of drug has leaked from the drug container, this plays a significant role in preventing exposure of the drug because the drug is likely to flow along the grooves or ribs.

In the above-described drug container storage device, it is possible that a through hole is formed in the closing portion, and a valve member that is inserted into the through hole is provided. In addition, it is possible that the valve member is configured such that when the second opening is hermetically sealed by the closing portion, the valve member is configured to close the through hole and protrude from the through hole. With this configuration, when the closing portion closes, the valve member protrudes from the through hole. Thus, it is possible to visually confirm that the closing portion has closed.

In the above-described drug container storage device, it is possible that the elastic sealing portion is configured to be fitted into the first opening by being compressed in a radial direction. This configuration makes it possible to firmly close the first opening, and the hermetic sealing effect can be enhanced.

A drug container storage system according to the present invention includes a plurality of drug container storage devices according to the foregoing descriptions, and a connecting mechanism configured to connect the plurality of drug container storage devices such that the first openings face in the same direction.

With this configuration, since the above-described plurality of drug container storage devices are connected, it is possible to collectively shake a plurality of drug containers to dissolve drugs, and thus the dissolving efficiency is improved. Moreover, during sucking of the drug using the syringe, it is possible to suck the drugs out of the drug container storage devices that are connected, and the operability can be enhanced.

Various configurations of the connecting mechanism can be conceived. For example, a configuration is possible in which at least one protruding portion and at least one recessed portion are formed on an outer circumferential surface of the main body portion, the protruding portion and the recessed portion extending in an axial direction, and the connecting mechanism is configured by the protruding portion and the recessed portion and is configured to connect the drug container storage devices by establishing engagement between the recessed portion and the protruding portion.

A method for sucking a drug according to the present invention includes preparing a syringe having a passage portion though which a liquid is sucked in and discharged, preparing at least one drug container having a lid portion into which the passage portion can be stabbed and containing a drug, preparing at least one drug container storage device having a closed space configured to accommodate the drug container, a first opening, and an elastic sealing portion configured to be attached to the first opening and into which the passage portion of the syringe can be stabbed, causing the drug container to be accommodated in the drug container storage device such that a space is formed between the lid portion of the drug container and the elastic sealing portion, stabbing the passage portion of the syringe into the elastic sealing portion and the lid portion, sucking the drug in the drug container into the syringe, and withdrawing the passage portion of the syringe from the elastic sealing portion and the lid portion.

In the above-described method for sucking a drug, it is possible that the drug is in powder form, the method can further include producing a drug in liquid form by injecting a mixing solution contained in the syringe into the drug container, prior to sucking the drug, and in sucking the drug in the drug container into the syringe, the drug in liquid form is sucked.

Moreover, in the above-described method for sucking a drug, it is possible that any one of the above-described methods for sucking a drug is repeated a plurality of times with respect to a plurality of different said drugs to suck the plurality of drugs into one syringe as defined above.

### Advantageous Effects of Invention

According to the present invention, during mixing of a drug with a mixing solution using a syringe, even if the drug leaks or vaporizes from a drug container, the drug can be kept in a closed space, and exposure can be prevented from extending to the outside.

### BRIEF DESCRIPTION OF DRAWINGS

FIG. 1 is a perspective view of a drug container storage device according to a first embodiment of the present invention.

FIG. 2 is a cross-sectional view of the device in FIG. 1.

FIG. 3 is a side view of a drug container to be accommodated in the device in FIG. 1.

FIG. 4 is an explanatory diagram of an operation for causing the drug container in FIG. 3 to be accommodated in the drug container storage device in FIG. 1.

FIG. 5 is an explanatory diagram of an operation for performing sucking of a drug using the drug container storage device in FIG. 1.

FIG. 6 is a side view of a mixing solution container.

FIG. 7 is a perspective view of a drug container storage device according to a second embodiment of the present invention.

FIG. 8 shows side cross-sectional views of the drug container storage device in FIG. 7 in a state in which the drug container is accommodated.

FIG. 9(a) is a cross-sectional view of a valve element in an open state and its vicinity, and FIG. 9(b) is a cross-sectional view of the valve element in a closed state and its vicinity.

FIG. 10 is a cross-sectional view taken in the direction of arrows X-X in FIG. 8.

FIG. 11 is a side cross-sectional view of a main body upper portion.

FIG. 12 is a side cross-sectional view of the drug container storage device in FIG. 7 in a distribution stage.

FIG. 13 is a perspective view of a drug container storage device according to a third embodiment.

FIG. 14 is a side cross-sectional view of a syringe adapter.

FIG. 15 is a bottom view of a bottle stopper accommodating portion.

FIG. 16 is a perspective view of the bottle stopper accommodating portion.

FIG. 17 is a perspective view of the bottle stopper accommodating portion in a state in which the drug container is supported by the bottle stopper accommodating portion.

FIG. 18 shows cross-sectional views of another example of the drug container storage device in FIG. 1.

FIG. 19 shows cross-sectional views showing another example of the drug container storage device in FIG. 1.

FIG. 20 is a perspective view showing an embodiment of a drug container storage system according to the present invention.

FIG. 21 shows horizontal cross-sectional views showing an example of the drug container storage system in FIG. 20.

FIG. 22 is a horizontal cross-sectional view showing another example of the drug container storage device in FIG. 1.

FIG. 23 shows cross-sectional views showing another example of the drug container storage device in FIG. 1.

FIG. 24 shows cross-sectional views showing another example of the drug container storage device in FIG. 1.

FIG. 25 shows cross-sectional views showing another example of the drug container storage device in FIG. 1.

FIG. 26 is a perspective view showing a bottle stopper accommodating portion according to a modification of the second embodiment.

FIG. 27 is another perspective view of the bottle stopper accommodating portion in FIG. 26.

FIG. 28(a) is a cross-sectional view of an elastic sealing member according to a modification, and FIG. 28(b) is a cross-sectional view of an elastic sealing member according to another modification.

### REFERENCE SIGN LIST

1 Drug container storage device
11 Main body portion
112 First opening
111 Second opening
114 Shoulder portion
115 Neck portion
12 Lid member (closing portion)
13 Elastic sealing member (elastic sealing portion)
14 Valve mechanism (closing portion)
142 Valve member
51 Protruding portion
52 Recessed portion
6 Drug container storage device
60 Main body upper portion (main body portion)
66 Elastic sealing member (elastic sealing portion)
69a Rib (protruding portion)
69b Rib (protruding portion)
70 Main body lower portion (main body portion, closing portion)
8 Drug container storage device
81 Bag (main body portion)
81a Zipper lock (closing portion)
85 Rib (protruding portion)
91 Rib (protruding portion)
S1, S2, S4 Space
H1 Through hole (first opening)
H2 Through hole (first opening)
H5 Through hole (second opening)
H6 Through hole (first opening)
H7 Through hole (first opening)

### DESCRIPTION OF EMBODIMENTS

Hereinafter, some embodiments of a drug container storage device, a drug container storage system, a method for sucking a drug, and a method for mixing a drug according to the present invention will be described with reference to the drawings.

### 1. First Embodiment

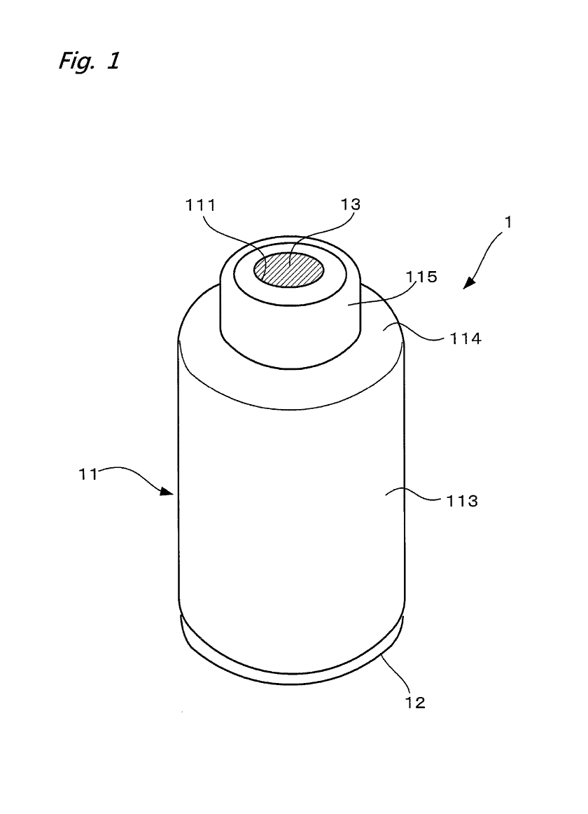

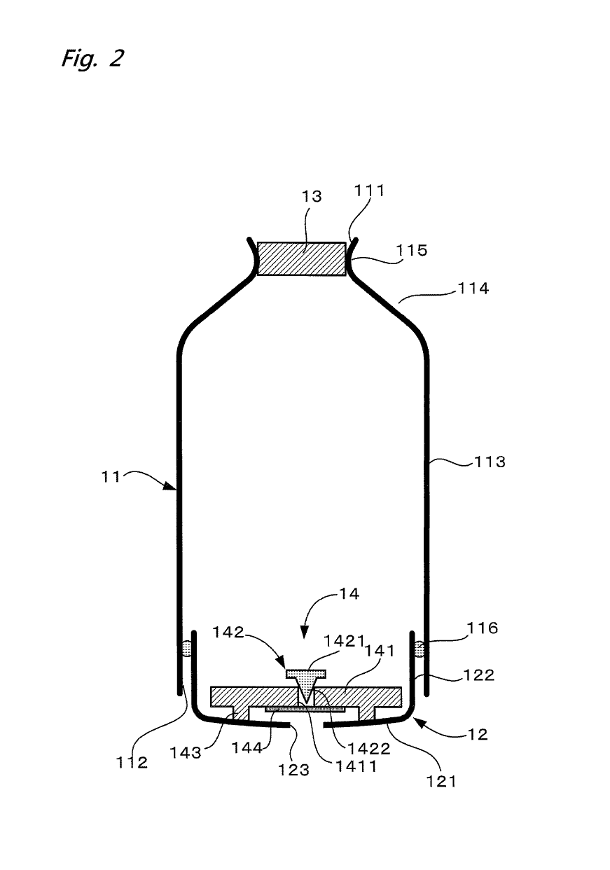

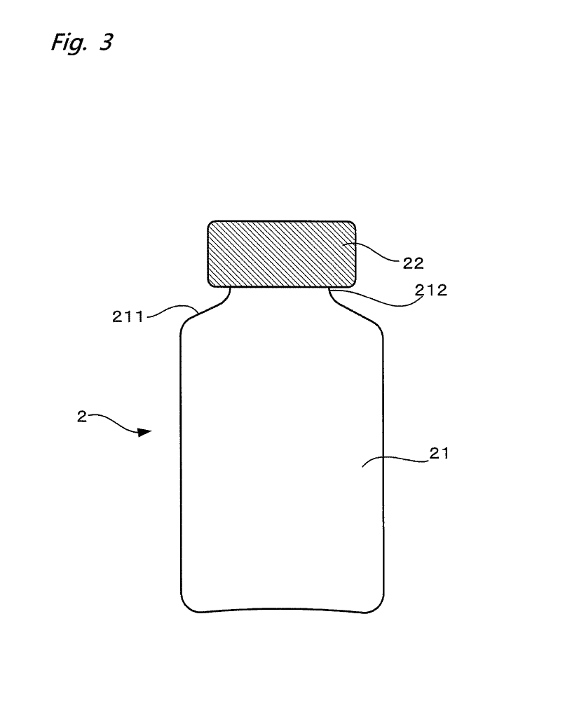

FIG. 1 is a perspective view of a drug container storage device 1 according to a first embodiment, FIG. 2 is a cross-sectional view of the device in FIG. 1, and FIG. 3 is a side view of a drug container 2. The drug container storage device 1 is a device for accommodating the drug container 2 in which a drug is contained and performing sucking of the drug contained in the drug container 2 using a syringe 3 or sucking of the drug after dissolving or diluting the drug with a mixing solution. A detailed description is given below.

1-1. Drug Container

First, the drug container 2 used in the present embodiment will be described. As shown in FIG. 3, this drug container 2 is a container that is commonly called “vial”, and has a bottle main body 21 made of glass and a bottle stopper 22 that closes an opening formed in an upper portion of the bottle main body 21. Although bottle main body 21 is formed into a substantially cylindrical column shape as a whole, a neck portion 212 having a small diameter is formed at an upper end portion of the bottle main body 21 via a shoulder portion 211. The bottle stopper (lid portion) 22 is attached to the neck portion 212. The bottle stopper 22 is fixed to the neck portion 212, with aluminum or the like wound and tightened therearound, such that the stopper blocks the opening of the bottle main body 21. The portion of the stopper that blocks the opening of the bottle main body 21 is formed of an elastically deformable material such as rubber or elastomer, and can be stabbed with a needle of the syringe 3 as described later.

The drug that is dealt with here is a drug, mainly a cytotoxic drug, that may, for example, produce serious side effects or cause health damage due to the cytotoxicity on a person (mainly medical personnel, hereinafter referred to as “user”) who handles the drug, if exposed. Examples of the above-described drug include antineoplastics, immunosuppressants, antiviral agents, antibiotics, radiopharmaceuticals, and the like. It should be noted that drugs are not only in the form of liquids but also in the form of powder and other forms, and any form of drug is hermetically sealed in the drug container 2 having the above-described structure.

1-2. Configuration of Drug Container Storage Device

Subsequently, the drug container storage device 1 will be described. As shown in FIGS. 1 and 2, the drug container storage device 1 according to the present embodiment includes a cylindrical tubular main body portion 11 having a closed space inside, and the above-described drug container 2 is accommodated in this main body portion 11. The main body portion 11 is formed of a transparent resin material such as plastic. Also, a first opening 111 and a second opening 112 are formed in respective end portions of the main body portion 11 that are opposite to each other in an axial direction. The first opening 111 is closed by an elastic sealing member 13, and the second opening 112 is closed by a lid member 12 formed of a transparent resin material. The closed space of the main body portion 11 thus becomes an airtight space that is hermetically sealed.

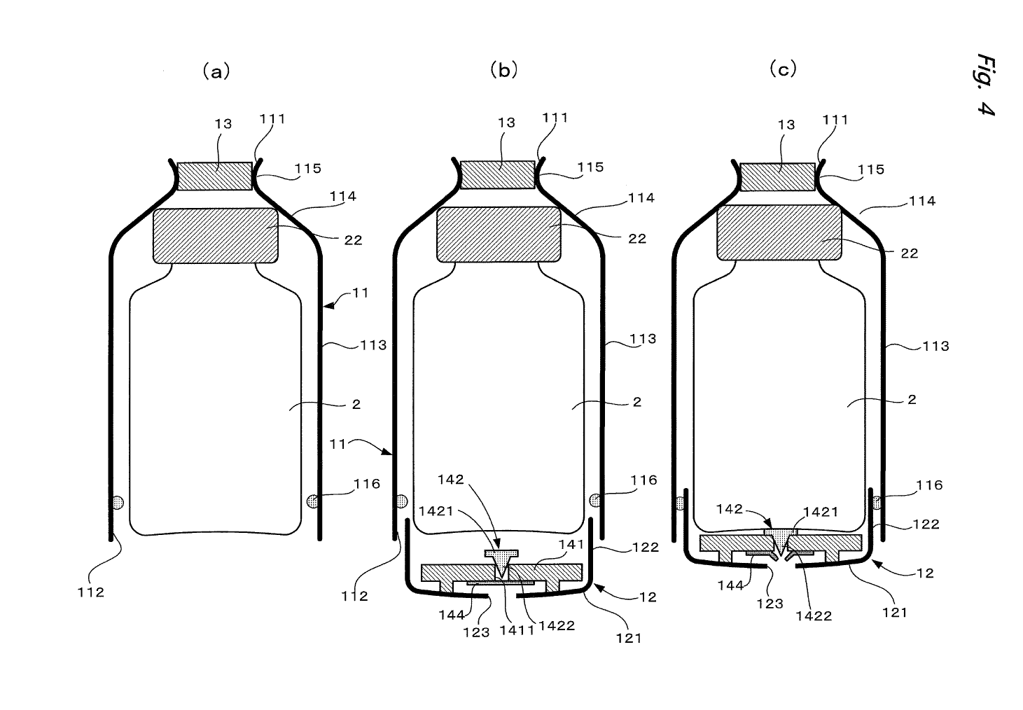

The main body portion 11 includes a cylindrical tube-shaped drum portion 113, and the second opening 112 to which the lid member 12 is attachable is formed in one (second end portion) of the end portions of the drum portion in the axial direction. Accordingly, the second opening 112 has substantially the same diameter as the drum portion 113. On the other hand, a shoulder portion 114 having a sloped surface that is sloped in a funnel shape is formed in the other end portion (first end portion) of the drum portion 113, and a neck portion 115 having a smaller diameter than the drum portion is formed in an end portion of the shoulder portion 114. The above-described first opening 111 is formed in this neck portion 115, and is closed by the elastic sealing member 13. The above-described drug container 2 is inserted into the second opening 112 with the bottle stopper 22 first, and is thus accommodated in the main body portion 11. As shown in FIG. 4, which will be described later, the diameter of the bottle stopper 22 is larger than the diameter of the neck portion 115, and thus allows the bottle stopper 22 to come into contact with the shoulder portion 114 of the main body portion 11. Therefore, a space S1 is formed between the bottle stopper 22 and the elastic sealing member 13. It should be noted that although not shown, a holding member for holding a syringe, which will be described later, may appropriately be provided in the neck portion 115, if necessary.

The elastic sealing member 13 is formed of an elastically deformable material such as rubber or elastomer, and is fitted into the first opening 111 in a state in which the elastically deformable material is compressed in a radial direction. The lid member 12 is formed into a cup shape constituted by a bottom surface portion 121 and a cylindrical tubular wall portion 122 extending upward from a peripheral edge of this bottom surface portion 121, and is configured so as to be inserted into an inner wall surface of the second opening 112. At this time, an outer circumferential surface of the wall portion 122 of the lid member 12 and an inner wall surface of the drum portion 113 closely adhere to each other via an O-ring 116 that is attached to the inner wall surface of the drum portion 113, and thus the second opening 112 is air-tightly closed.

Moreover, an air hole 123 is formed in the bottom surface portion 121 of the lid member 12, and a valve mechanism 14 is attached to a surface of the bottom surface portion that is located on the side of the drum portion 113 so as to block the air hole 123 from the inside. This valve mechanism 14 is constituted by a base plate 141 that is attached to the bottom surface portion 121 of the lid member 12 and a valve member 142 that is attached to this base plate 141. The base plate 141 is attached to the bottom surface portion 121 of the lid member 12 via an annular connecting member 143, and a space is formed between the base plate 141 and the bottom surface portion 121. Moreover, a through hole 1411 is formed in the base plate 141, and the through hole 1411 is blocked by an air-permeable colored sheet 144 that is disposed on a surface of the base plate 141 that is located on the side of the lid member 12. Furthermore, the above-described valve member 142 is fitted into the through hole 1411 of the base plate 141 from the side of the drum portion 113. This valve member 142 is constituted by a base portion 1421 having a larger diameter than the through hole 1411 and a cone-shaped protruding portion 1422 protruding from the base portion 1421 and fitted into the through hole 1411. With this configuration, when the valve member 142 is pressed from the side of the drum portion 113, the protruding portion 1422 of the valve member 142 is further fitted into the through hole 1411, and thus the through hole 1411 is air-tightly closed. When the through hole 1411 is closed by the valve member 142 in this manner, even though the air hole 123 is formed in the lid member 12, communication of air between the inside and the outside of the lid member 12 is stopped. It should be noted that the lid member 12 and the valve mechanism 14 described here correspond to a closing portion of the present invention.

1-3. Method for Sucking Drug/Method for Mixing Drug

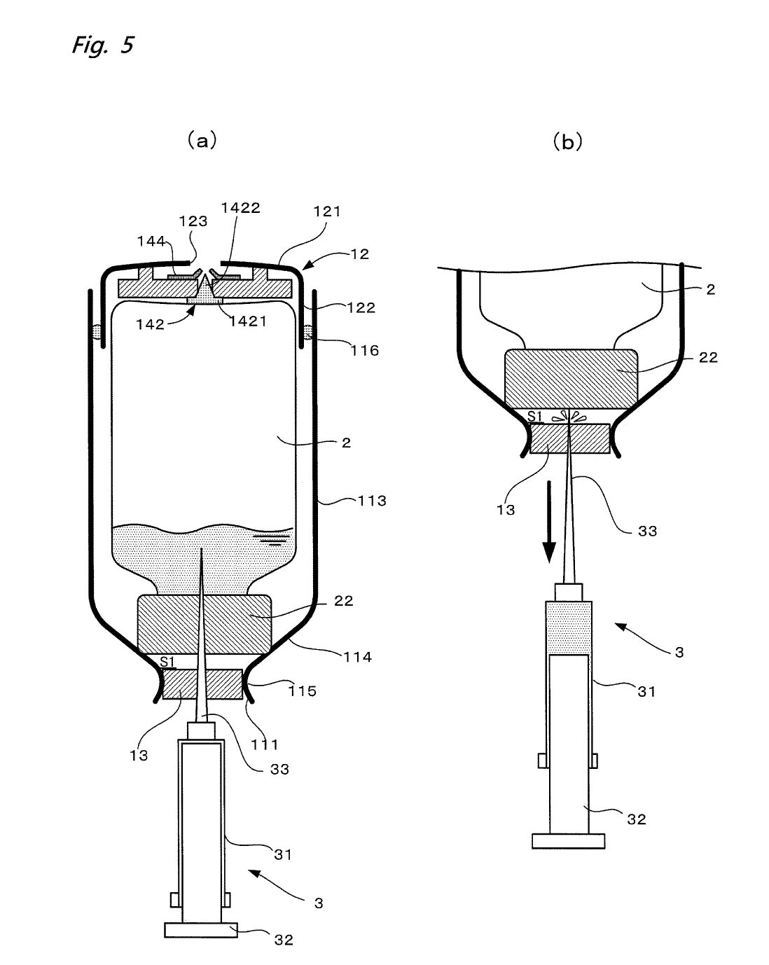

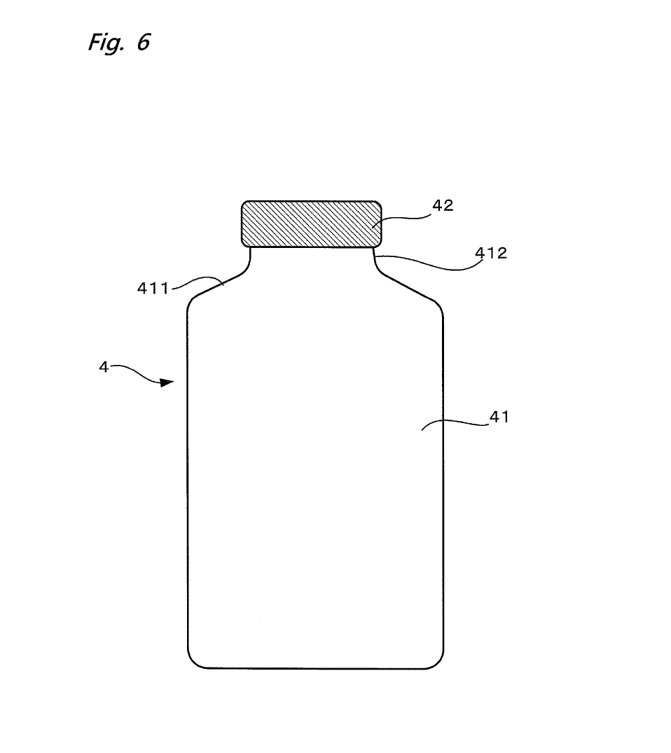

Next, a method for sucking the drug will be described with reference to FIGS. 5 and 6. Here, after the drug is sucked by the syringe 3, the drug is injected into a mixing solution container 4 containing a mixing solution to produce a mixed drug solution to be administered to a patient. The syringe 3 and the mixing solution container 4 that are used here will be described first.

As shown in FIG. 5, a known syringe can be used as the syringe 3 that is used in the present embodiment, and the syringe is constituted by a cylindrical tube-shaped cylinder 31 and a piston 32 that is movable in this cylinder 31. An opening through which a liquid is sucked in and discharged is provided at a leading end of the cylinder 31, and a needle 33 is fitted to this opening. In the present embodiment, this opening and the needle 33 constitute a passage portion of the present invention.

Then, the mixing solution container will be described. As shown in FIG. 6, the mixing solution container 4 has a bottle main body 41 made of plastic and a bottle stopper 42 that closes an opening formed in an upper portion of the bottle main body 41. The bottle main body 41 is formed into a substantially elliptical column shape as a whole, but similarly to the drug container 2, a neck portion 412 having a small diameter is formed in an upper end portion via a shoulder portion 411. The bottle stopper 42 is attached to this neck portion 412. The bottle stopper 42 is attached to the neck portion 412 by welding so as to block the opening of the bottle main body 41. As in the case of the drug container 2, the portion of the bottle stopper 42 that blocks the opening of the bottle main body 41 is formed of an elastic material such as rubber or elastomer and can be stabbed with the needle 33 of the syringe 3. It should be noted that the mixing solution container 4 is not necessarily required to be in the form of a bottle, and naturally, a container in the form of a bag can also be used.

The mixing solution that is contained in this mixing solution container 4 is a solution for diluting or dissolving the drug, such as a physiological saline, a Ringer's solution, distilled water, etc. It should be noted that mixing of the drug as referred to herein means any operation for producing a mixed drug solution in which the drug and the mixing solution are mixed, including an operation for preparing a medicine according to a prescription from a doctor, a dentist, or a veterinarian, a mixing operation that is performed by the patient himself/herself, and an operation that is performed by a pharmaceutical company or the like in order to manufacture a mixed drug solution.

Next, attachment of the drug container 2 to the drug container storage device 1 will be described with reference to FIG. 4. First, as shown in FIG. 4(a), the user inserts the drug container 2 into the main body portion 11 through the second opening 112 until the bottle stopper 22 abuts against the shoulder portion 114, and thus the drug container is accommodated in the main body portion 11. Then, as shown in FIG. 4(b), the user inserts the lid member 12 to close the second opening 112. At this time, as the lid member 12 is inserted, the bottom surface of the drug container 2 is pressed by the lid member 12, so that the drug container 2 is tightly fixed between the shoulder portion 114 and the lid member 12. Moreover, when the bottom surface of the drug container 2 is pressed by the lid member 12, the valve member 142 is pushed into the through hole 1411 of the base plate 141, so that the protruding portion 1422 air-tightly closes the through hole 1411. In this process, the valve member 142 gradually closes the through hole 1411, and thus air can flow to the outside. After that, the protruding portion 1422 of the valve member 142 breaks the colored sheet 144 and protrudes from the through hole 1411. Thus, when the breakage of the colored sheet 144 is visually observed, it is possible to confirm that the lid member 12 is tightly closed. When the lid member 12 is closed in this manner, the drug container 2 is accommodated in the main body portion 11 in an air-tight state. In the same manner, the user prepares a plurality of drug container storage devices 1 in which the same drug or different drugs are contained.

When the drug container 2 is thus accommodated in the device 1, the user stabs the needle 33 of the syringe 3 into the elastic sealing member 13. When the needle 33 is further stabbed, the needle 33 enters the main body portion 11 and is then stabbed into the bottle stopper 22 of the drug container 2. At this time, only a small amount of drug is contained in the drug container 2. For this reason, in order to make it easier to suck the whole amount of drug using the syringe 3, as shown in FIG. 5(a), the orientation of the device 1 is changed such that the drug accumulates on the side of the bottle stopper 22. After that, when the needle 33 enters the drug container 2 through the bottle stopper 22 and comes into contact with the drug, the piston 32 is pulled to suck the drug. Then, when a predetermined amount of drug has been sucked into the cylinder 31, as shown in FIG. 5(b), the needle 33 is withdrawn from the drug container 2 and the elastic sealing member 13. It should be noted that the predetermined amount refers to, for example, in the case of an anticancer drug, a dosage of the drug that is determined based on the body surface area, weight, age, and the like of the patient. At this time, even if the drug leaks from the drug container 2 at the time of withdrawal of the needle 33, this drug leaks into the space S1 between the bottle stopper 22 and the elastic sealing member 13 in the main body portion 11, and thus leakage of the drug from the main body portion 11 to the outside can be prevented. In particular, during withdrawal of the needle 33 from the elastic sealing member 13, the needle 33 is withdrawn while being rubbed against the elastic sealing member 13, and thus the drug adhering to the needle 33 remains in the space S1.

When the predetermined amount of drug have been sucked from the drug container 2 in this manner, the user sucks a drug from another drug container storage device 1 in the same manner while keeping the drug in the syringe 3. Then, when a plurality of drugs are contained in the syringe 3, the user stabs the needle 33 of the syringe 3 into the bottle stopper 42 of the mixing solution container 4 and pushes the piston 32 inward. Thus, all the drugs in the syringe 3 are injected in to the mixing solution container 4, and the drugs and the mixing solution are mixed together. In this manner, the mixed drug solution is produced.

After that, the user carries the mixing solution container 4 containing the mixed drug solution to the patient, and administers the mixed drug solution in the mixing solution container 4 to the patient by an intravenous infusion or other methods. Subsequently, the user disposes of the syringe 3 and the drug container storage device 1. At this time, the drug container 2 is not removed from the drug container storage device 1 and is disposed together with the device 1 while remaining accommodated in the closed space, and is thus prevented from being exposed to the outside. Therefore, the device 1, the drug container 2, and the syringe 3 that are contaminated with the drug can be safely disposed.

Although a case where the drug is in the form of a liquid has been described above, in the case where the drug is in the form of powder, the method is performed in the following manner. First, the needle 33 of the syringe 3 is stabbed into the mixing solution container 4, and the mixing solution is sucked into the syringe 3. Subsequently, the needle 33 of the syringe 3 is stabbed into the elastic sealing member 13 of the drug container storage device 1, and the needle 33 is further stabbed into the drug container 2. In this state, the piston 32 is pushed inward to inject the mixing solution in the syringe 3 into the drug container 2. Thus, the drug in the form of powder is mixed with the mixing solution, and a drug in the form of a liquid is produced. After that, this liquid drug is sucked and held in the syringe 3. Subsequently, the needle 33 of the syringe 3 is stabbed into the bottle stopper 42 of the mixing solution container 4, and the drug in the syringe 3 is injected into the mixing solution container 4. In this manner, with respect to other drugs, a liquid drug is also produced by injecting the mixing solution, sucked into the syringe 3, and then mixed with the mixing solution. Thus, a mixed drug solution is produced as described above. It should be noted that the mixing solution that is injected into the drug container 2 is not necessarily limited to the mixing solution that is sucked from the mixing solution container 4 for producing the mixed drug solution, and other mixing solutions for dissolution or dilution can also be used.

1-4. Features

As described above, according to the present embodiment, the drug container 2 can be accommodated in the closed space that is hermetically sealed, and furthermore, the drug container 2 is accommodated such that the space S1 is formed between the bottle stopper 22 of the drug container 2 that is accommodated in the main body portion 11 and the elastic sealing member 13 that hermetically seals the first opening 111 of the main body portion 11. Therefore, during withdrawal of the needle 33 of the syringe 3 after passing the needle 33 through the elastic sealing member 13 and the bottle stopper 22 and sucking the drug into the syringe 3, even if the drug leaks from the drug container 2, the drug that has leaked remains in the space S1 between the bottle stopper 22 and the elastic sealing member 13, so that the drug can be confined in the closed space. As a result, during sucking of the drug into the syringe 3, exposure of the drug can be prevented from extending to the outside of the elastic sealing member 13. Also, since the drug container 2 is hermetically sealed in the drug container storage device 1, the drug container 2 can be disposed without exposing the drug to the outside by simply disposing of the drug container storage device 1 as is.

### 2. Second Embodiment

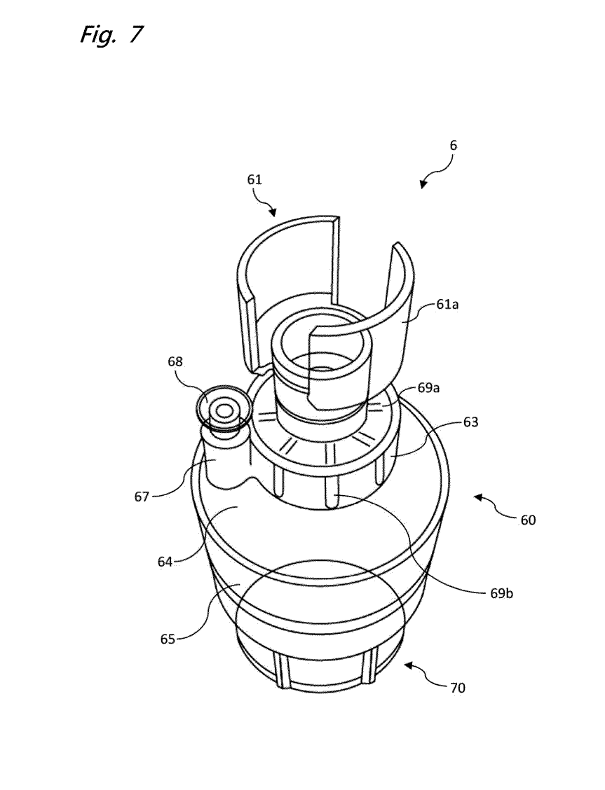

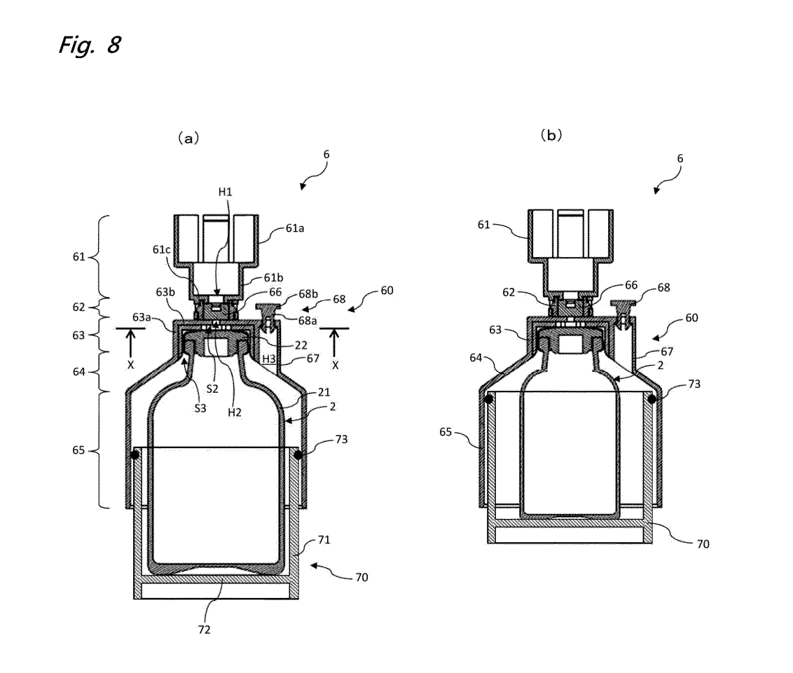

Hereinafter, a drug container storage device 6 according to a second embodiment will be described. FIG. 7 is a perspective view of the drug container storage device 6. Similarly to the drug container storage device 1 according to the first embodiment, the drug container storage device 6 also is a device for accommodating the drug container 2 and performing sucking of the drug contained in the drug container 2 using the syringe 3. Likewise, similarly to the first embodiment, the drug may be dissolved or diluted with the mixing solution in the drug container 2 using the syringe 3, prior to sucking of the drug. FIG. 8 shows cross-sectional views of the drug container storage device 6, illustrating respective states in which two drug containers 22 having different sizes are accommodated in the device. In this manner, the drug container storage device 6 is capable of accommodating drug containers 2 of various sizes. It should be noted that the drug container 2, the syringe 3, and the mixing solution container 4 that are used in the second embodiment are the same as those of the first embodiment, and detailed descriptions thereof are omitted here. The following is a description of the drug container storage device 6 according to the second embodiment, focusing on differences from the first embodiment.

2-1. Configuration of Drug Container Storage Device

As shown in FIGS. 7 and 8, the drug container storage device 6 has a main body upper portion 60 and a main body lower portion 70, and these portions 60 and 70 are combined with each other to form a generally cylindrical column-shaped space (closed space) for accommodating the drug container 2 inside. The main body upper portion 60 and the main body lower portion 70 are formed of a transparent resin material such as plastic. It should be noted that in the description of the present embodiment, the top-bottom direction and the horizontal direction are defined as shown in FIG. 8, that is, based on a state in which the bottle stopper 22 of the drug container 2 that is accommodated in the drug container storage device 6 is located on the upper side of the bottle main body 21, and are not related to the vertical direction with respect to the usage state of the drug container storage device 6 unless otherwise specified.

As shown in FIG. 8, the main body upper portion 60 has a syringe supporting portion 61 that forms a space for receiving a portion of the cylinder 31 that is located in the vicinity of the base of the needle 33, and a bottle stopper accommodating portion 63 that forms a space for receiving the bottle stopper 22 of the drug container 2. The syringe supporting portion 61 has a generally cylindrical tubular shape, and more precisely has a structure in which a cylindrical tubular member 61b having a smaller diameter is coaxially connected to a lower side of a cylindrical tubular member 61a having a larger diameter so as to correspond to the portion (see FIG. 5 etc.) of the cylinder 31 that is located in the vicinity of the base of the needle 33 and that has a two-step structure. Thus, the syringe supporting portion 61 can tightly receive the syringe 3 and can align the needle 33 with the bottle stopper 22 of the drug container 2. Moreover, as shown in FIG. 7, a plurality of portions (two portions in the example shown in FIG. 7) of the upper-side cylindrical tubular member 61a that are substantially equally spaced apart in the circumferential direction are cut away, and thus, during insertion of the cylinder 31, the cylindrical tubular member 61a easily deforms in accordance with the diameter of the cylinder 31. It should be noted that an upper portion of the upper-side cylindrical tubular member 61a is open, and the cylinder 31 and the needle 33 are inserted into the space in the syringe supporting portion 61 through this portion.

On the other hand, a disc-shaped bottom wall 61c extending in the horizontal direction is continuous with a lower end edge of the lower-side cylindrical tubular member 61b, and a through hole H1 (first opening) for the needle 33 of the syringe 3 to pass therethrough is formed in the center of the bottom wall 61c. Moreover, an elastic sealing member 66 is attached to a lower surface of the bottom wall 61c with no gap therebetween so as to air-tightly block the through hole H1 from below. The elastic sealing member 66 is formed of an elastically deformable material such as rubber or elastomer, and can be stabbed with the needle 33 of the syringe 3 that has passed through the through hole H1. The elastic sealing member 66 has a generally cylindrical column shape, and in order to reduce the thickness of this member so as to make it easier for the needle 33 to pass therethrough, an indentation is formed in about the center of an upper surface of this member to such an extent that the indentation does not reach all the way to a bottom surface. Moreover, the entire circumferential surface of the elastic sealing member 66 is air-tightly covered by a cylindrical tubular member 62 constituting a portion of the main body upper portion 60, with no gap therebetween. The elastic sealing member 66 and the bottom wall 61c are coaxially arranged. It should be noted that it is also possible to integrally form the elastic sealing member 66 and the syringe supporting portion 61 and thereby reduce the number of components.

The bottle stopper accommodating portion 63 has a side surface portion 63a having a cylindrical tubular shape that is open at upper and lower ends, and a disc-shaped upper surface portion 63b that is continuous with an upper end edge of the side surface portion 63a. A through hole H2 (first opening) for the needle 33 of the syringe 3 to pass therethrough is formed in the center of the upper surface portion 63b. The bottom surface of the elastic sealing member 66 and the cylindrical tubular member 62 that protects the elastic sealing member 66 are in contact with and fixed to the upper surface portion 63b. Accordingly, the through hole H2 is air-tightly blocked by the elastic sealing member 66 without any gap. The upper surface portion 63b and the elastic sealing member 66 are coaxially arranged.

The main body upper portion 60 further has a cylindrical tubular lower portion 65 having a larger diameter than the side surface portion 63a of the bottle stopper accommodating portion 63, and a funnel-shaped sloped surface portion 64 that is continuous with an upper end edge of this lower portion 65 and a lower end edge of the side surface portion 63a. All of the bottle stopper accommodating portion 63, the sloped surface portion 64, and the lower portion 65 are coaxially arranged.

Moreover, the main body upper portion 60 has a communication passage forming member 67 that forms a communication passage H3 that establishes communication from an internal space of the drug container storage device 6 to an external space, and a valve element 68 that is capable of closing this communication passage H3. The communication passage forming member 67 is a cylindrical tubular member extending upward from the sloped surface portion 64 along a side surface of the bottle stopper accommodating portion 63 and is integrally formed with the bottle stopper accommodating portion 63. The valve element 68 is disposed in an opening of the communication passage forming member 67 on the upper end side, and an upper portion of the communication passage forming member 67 constitutes a valve seat that supports the valve element 68.

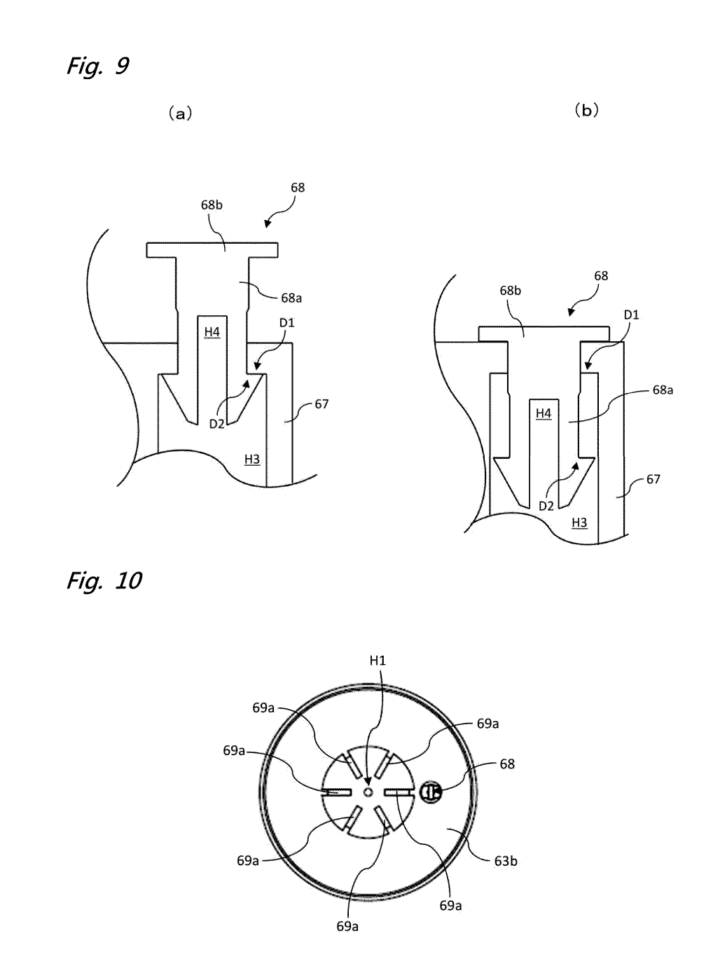

The valve element 68 has a drum portion 68a that is inserted into the communication passage H3 defined by the communication passage forming member 67, and a lid portion 68b that is continuous with an upper surface of the drum portion 68a. The lid portion 68b is a disc-shaped member having a larger diameter than the communication passage H3, and is therefore configured so as to prevent the drum portion 68a from dropping in the communication passage H3. On the other hand, the drum portion 68a is a generally cylindrical column-shaped member, and in a state in which the drum portion 68a is not inserted into the communication passage H3, the diameter of the drum portion 68a is slightly larger than the diameter of the communication passage H3. However, due to the elasticity of the resin materials that form the valve element 68 and the communication passage forming member 67, when an attempt to insert the drum portion 68a into the communication passage H3 is made, the drum portion 68a and the communication passage forming member 67 deform and thus allow the insertion. As a result, in a state in which the drum portion 68a is inserted into the communication passage H3, an outer circumferential surface of the drum portion 68a and an inner circumferential surface of the communication passage forming member 67 are in air-tight contact with each other with no gap therebetween. Moreover, a slit H4 is formed in the drum portion 68a, extending upward from a bottom surface thereof (see FIG. 9). This slit H4 has a straight line-shape having a constant width in a horizontal cross-sectional view, and extends across the center of the drum portion 68a and reaches the outer circumference of the drum portion 68a. Accordingly, the lower portion of the drum portion 68a has a bifurcated shape, and the legs of the bifurcation are biased outward, with respect to a radial direction, by the elasticity of the resin material that forms the drum portion 68a. As a result, a large frictional force is maintained between the outer circumferential surface of the drum portion 68a and the inner circumferential surface of the communication passage forming member 67, and the drum portion 68a is prevented from moving within the communication passage H3 unless a strong force is intentionally applied thereto from above.

As shown in FIG. 9, an upper portion of the communication passage forming member 67 is formed so as to constitute a thick portion that protrudes slightly further inward, with respect to the radial direction, than a lower portion of the communication passage forming member 67. As a result, a step D1 is formed in an upper portion of the communication passage H3. In addition, a step D2 corresponding to this step D1 is also formed in the lower portion of the drum portion 68a. These steps D1 and D2 prevent the drum portion 68a when once inserted into the communication passage H3 from dropping out of the communication passage H3, by tightly engaging with each other.

Moreover, as shown in FIG. 9(a), in a state in which the steps D1 and D2 tightly engage with each other, an upper portion of the slit H4 is located above an upper end of the communication passage forming member 67. Accordingly, in this state, the communication passage H3 that is in communication with the internal space of the drug container storage device 6 is open to the external space via the slit H4. On the other hand, as shown in FIG. 9(b), when the lid portion 68b is pushed toward the inside of the communication passage H3, by a strong force being applied from above with the finger or the like, until the lower surface of the lid portion 68b comes into tight contact with the upper surface of the communication passage forming member 67, the communication passage H3 that is in communication with the internal space of the drug container storage device 6 is closed from the external space.

Now, the description returns to the bottle stopper accommodating portion 63. FIG. 10 is a cross-sectional view taken in the direction of arrows X-X in FIG. 8. As shown in FIG. 10, a plurality of (six, in the present embodiment) ribs 69a (protruding portions) are formed on a lower surface (first opposing surface) of the upper surface portion 63b of the bottle stopper accommodating portion 63, the ribs 69a being radially arranged at regular intervals around the through hole H1. As described above, the bottle stopper accommodating portion 63 defines the space for receiving the bottle stopper 22 of the drug container 2, and these ribs 69a keep a certain distance between a top surface of the bottle stopper 22 of the drug container 2 and the lower surface of the upper surface portion 63b of the bottle stopper accommodating portion 63 that opposes the top surface. As a result, a space S2 for accommodating the drug leaking from the drug container 2 is secured between the top surface of the bottle stopper 22 and the elastic sealing member 66. Therefore, the space S2 that is capable of accommodating the drug leaking from the drug container 2 can be secured with a simple structure.

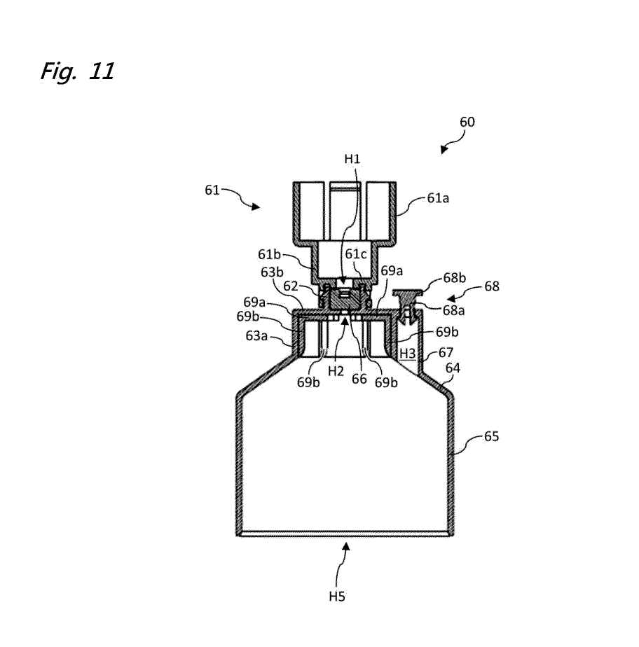

FIG. 11 is a cross-sectional view of the main body upper portion 60. As shown in FIG. 11, a plurality of (six, in the present embodiment) ribs 69b (protruding portions) are formed on an inner circumferential surface (second opposing surface) of the side surface portion 63a of the bottle stopper accommodating portion 63, the ribs 69b being arranged at regular intervals in the circumferential direction. In the present embodiment, these ribs 69b are continuous with the respective ribs 69a described above, and extend from near the top surface of the bottle stopper 22 of the drug container 2 to near the lower end of the bottle stopper 22. Accordingly, these ribs 69b keep a certain distance between a side surface of the bottle stopper 22 of the drug container 2 and the inner circumferential surface of the side surface portion 63a of the bottle stopper accommodating portion 63 that opposes this side surface. As a result, a certain space S3 is secured between the side surface of the bottle stopper 22 and the side surface portion 63a of the bottle stopper accommodating portion 63. Accordingly, the drug dropping into the above-described space S2 is guided by these ribs 69b and moves within the space S3 from near the top surface of the bottle stopper 22 to near the lower end of the bottle stopper 22, and afterward, reaches a space between the outer circumferential surface of the bottle main body 21 and the sloped surface portion 64, the lower portion 65, and the main body lower portion 70. Therefore, the drug leaking from the drug container 2 can be caused to move away from the through holes H1 and H2, so that leakage of the drug through the through holes H1 and H2 can be reliably prevented. In particular, in cases where a large amount of drug has leaked from the drug container, this plays a significant role in preventing exposure of the drug.

Hereinafter, the configuration of the main body lower portion 70 will be described in detail. As shown in FIG. 8, the main body lower portion 70 has a cylindrical tubular side wall portion 71 and a disc-shaped bottom surface portion 72 that is located slightly above a lower end of the side wall portion 71 and that extends in the horizontal direction, and is formed into a generally cup-like shape. The outer diameter of the side wall portion 71 is substantially equal to the inner diameter of the lower portion 65 of the main body upper portion 60. An opening H5 (second opening) through which the drug container 2 is accommodated in the main body upper portion 60 is formed at a lower end side of the lower portion 65 of the main body upper portion 60 (see FIG. 11), and the main body lower portion 70 can close this opening H5 by being inserted into the main body upper portion 60. At this time, an outer circumferential surface of the side wall portion 71 and the inner circumferential surface of the lower portion 65 of the main body upper portion 60 closely adhere to each other via an O-ring 73 that is attached to the outer circumferential surface of the side wall portion 71 at a position near an upper end thereof, and thus the opening H5 is air-tightly closed.

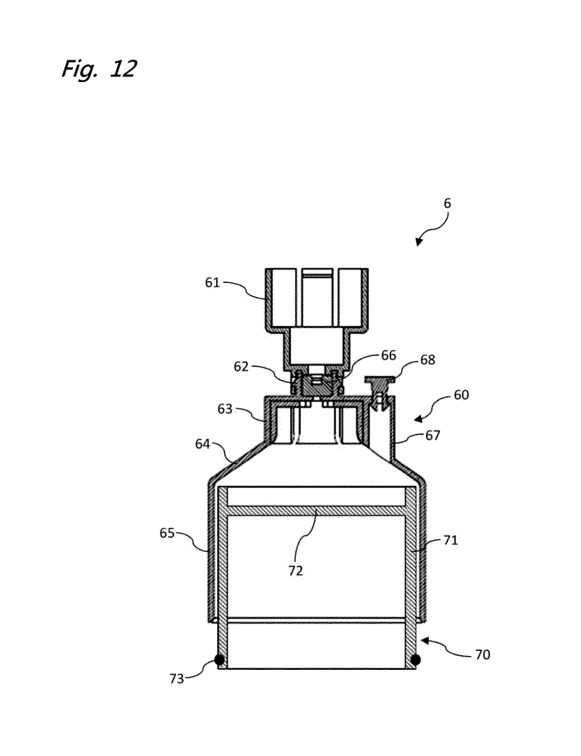

It should be noted that in a distribution stage, the drug container storage device 6 is preferably in a state in which the main body lower portion 70 is inserted into the main body upper portion 60 upside down as compared with the usage state. That is to say, as shown in FIG. 12, a state in which the main body lower portion 70 is inserted from the side of the bottom surface portion 72 rather than the side of the O-ring 73 is preferable. This prevents the drug container storage device 6 from becoming bulky, and also prevents a situation in which the pressure contact of the O-ring 73 makes it difficult to remove the main body lower portion 70 out of the main body upper portion 60 prior to causing the drug container 2 to be accommodated in the drug container storage device 6.

2-2. Method for Sucking Drug/Method for Mixing Drug

The following describes a method for sucking a drug according to the second embodiment, focusing on differences from the first embodiment. First, the user inserts the drug container 2 into the main body upper portion 60 via the opening H5 and pushes the drug container 2 into the main body upper portion 60 until the top surface of the bottle stopper 22 abuts against the ribs 69a that are formed on the upper surface portion 63b of the bottle stopper accommodating portion 63. Then, the user inserts the main body lower portion 70 into the main body upper portion 60 to close the opening H5. At this time, as the main body lower portion 70 is inserted, the bottom surface of the drug container 2 is pressed by the main body lower portion 70, and thus the drug container 2 is tightly fixed between the upper surface portion 63b of the bottle stopper accommodating portion 63 and the bottom surface portion 72 of the main body upper portion 60. In this process, the valve element 68 keeps the communication passage H3 open, and thus air can flow to the outside via the communication passage H3. After that, the user closes the communication passage H3 by pushing the drum portion 68a of the valve element 68 into the communication passage forming member 67 as far as possible by applying a strong force to the lid portion 68b of the valve element 68 from above with the finger or the like. When the main body lower portion 70 and the valve element 68 are closed as described above, the drug container 2 is accommodated in the main body portion 11 in an air-tight state. In the same manner, the user prepares a plurality of drug container storage devices 6 in which the same drug or different drugs are contained. The operations after this process are the same as those of the first embodiment, and descriptions thereof are omitted.

2-3. Features

As described above, also in the second embodiment, the drug container 2 can be accommodated in the closed space that is hermetically sealed, and furthermore, the drug container 2 is accommodated in the main body upper portion 60 and the main body lower portion 70 such that the space S2 is formed between the bottle stopper 22 of the drug container 2 and the elastic sealing member 66 that hermetically seals the through hole H2 of the main body upper portion 60. Therefore, during withdrawal of the needle 33 of the syringe 3 after passing the needle 33 through the elastic sealing member 66 and the bottle stopper 22 and sucking the drug into the syringe 3, even if the drug leaks from the drug container 2, the drug that has leaked remains in the space S2 between the bottle stopper 22 and the elastic sealing member 66, so that the drug can be confined in the closed space. As a result, during sucking of the drug into the syringe 3, exposure of the drug can be prevented from extending to the outside of the elastic sealing member 66. Also, since the drug container 2 is hermetically sealed in the drug container storage device 6, the drug container 2 can be disposed without exposing the drug to the outside by simply disposing of the drug container storage device 6 as is.

### 3. Third Embodiment

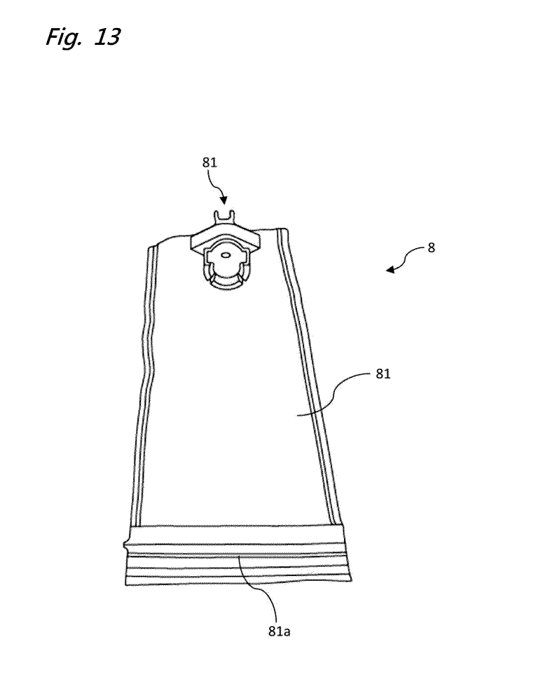

Hereinafter, a drug container storage device 8 according to a third embodiment will be described. FIG. 13 is an external view of the drug container storage device 8. Similarly to the drug container storage devices 1 and 6 according to the first and second embodiments, the drug container storage device 8 also is a device for accommodating the drug container 2 and performing sucking of the drug contained in the drug container 2 using the syringe 3. Likewise, similarly to the first and second embodiments, the drug may be dissolved or diluted with the mixing solution in the drug container 2 using the syringe 3 prior to sucking of the drug. It should be noted that the drug container 2, the syringe 3, and the mixing solution container 4 that are used in the third embodiment are the same as those of the first and second embodiments, and descriptions thereof are omitted here. The following is a description of the drug container storage device 8 according to the third embodiment, focusing on differences from the first and second embodiments.

3-1. Configuration of Drug Container Storage Device

As shown in FIG. 13, the drug container storage device 8 according to the third embodiment differs from the drug container storage devices 1 and 6 according to the first and second embodiments mainly in that the drug container 2 is accommodated in a deformable soft bag instead of a hard container. Thus, the drug container storage device 8 according to the third embodiment is capable of accommodating drug containers of a wider variety of sizes and shapes than the drug container storage devices 1 and 6 according to the first and second embodiments, and therefore the drug container storage device 8 can deal with drug containers of various sizes and shapes.

Specifically, the drug container storage device 8 has a generally rectangular bag 81 that forms a space (closed space) for accommodating the drug container 2, and a syringe adapter 82 that is disposed on an upper portion of the bag 81 and that guides the needle 33 of the syringe 3 into the bag 81. The bag 81 is formed of a resin material such as soft plastic, whereas the syringe adapter 82 is formed of a resin material such as hard plastic. It should be noted that in the description of the present embodiment, the top-bottom direction and the horizontal direction are defined assuming that, as shown in FIG. 13, the bag 81 is on the lower side and the syringe adapter 82 is on the upper side, and are not related to the vertical direction with respect to the usage state of the drug container storage device 6 unless otherwise specified.

A zipper lock 81a that can open and close a space in the bag 81 is formed in the vicinity of a lower portion of the bag 81. The zipper lock 81a can be air-tightly closed. On the other hand, an opening (second opening) that is formed by opening the zipper lock 81a serves as an opening through which the drug container 2 is accommodated in the bag 81.

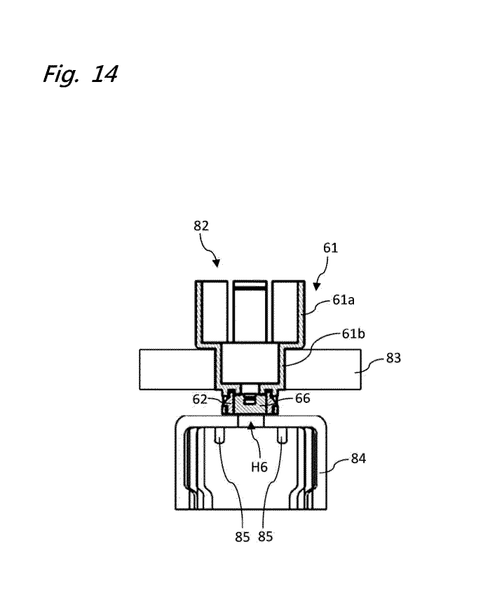

FIG. 14 is a side cross-sectional view of the syringe adapter 82. As shown in FIG. 14, the syringe adapter 82 has the syringe supporting portion 61, the cylindrical tubular member 62, and the elastic sealing member 66 that are similar to those of the second embodiment. The configurations, functions, positional relationships, etc. of these members 61, 62, and 66 are entirely the same as those of the second embodiment, and descriptions thereof are omitted here.

Moreover, the syringe adapter 82 has a doughnut-shaped plate member 83, and the cylindrical tubular member 61b is inserted into an opening in the center of this plate member 83. These members 83 and 61b have generally the same thickness in the top-bottom direction. An upper central portion of the bag 81 is air-tightly bonded to an outer circumferential surface of the doughnut-shaped plate member 83 with no gap therebetween by a welding method, such as heat sealing or ultrasonic sealing, or other known methods such as a method that uses an adhesive. Accordingly, at a joint portion between the bag 81 and the plate member 83, the internal space of the bag 81 is isolated from the external space. Moreover, the doughnut-shaped plate member 83 and the cylindrical tubular member 61b in the center thereof are in air-tight contact with each other without any gap therebetween. Accordingly, at the joint portion between the member 83 and the member 61b, the internal space of the bag 81 is isolated from the external space as well.

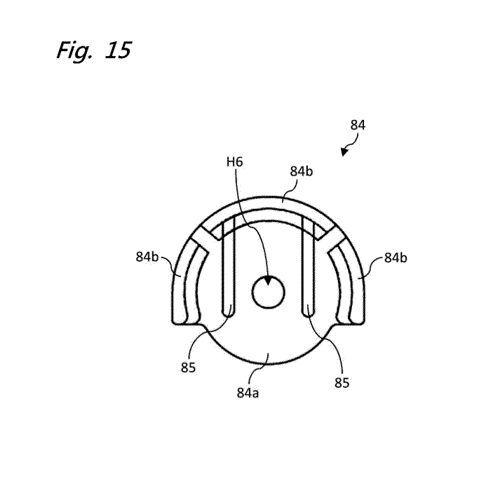

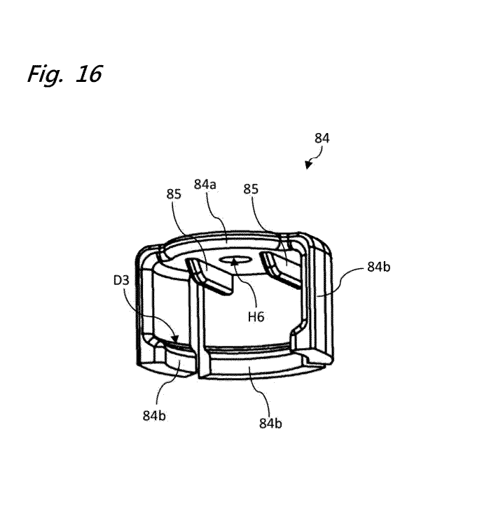

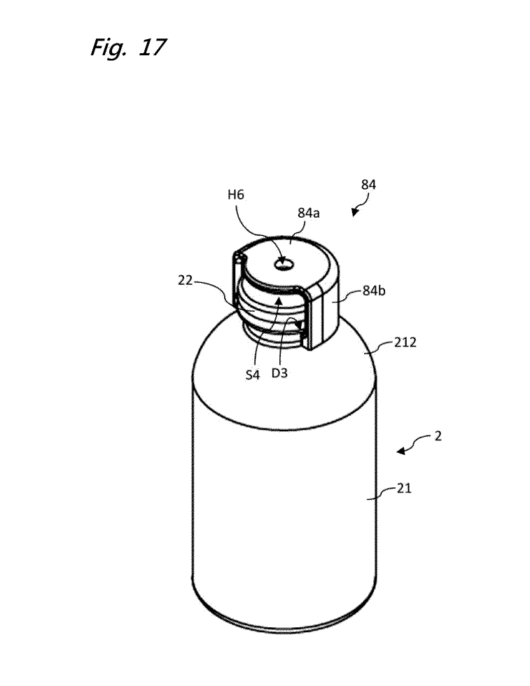

Moreover, the syringe adapter 82 has a bottle stopper accommodating portion 84 that forms a space for receiving the bottle stopper 22 of the drug container 2, under the above-described cylindrical tubular member 62 and elastic sealing member 66. As shown in FIGS. 15 and 16, the bottle stopper accommodating portion 84 has a generally disc-shaped upper surface portion 84a, and a plurality of (three, in the present embodiment) side wall portions 84b extending downward from a peripheral edge of the upper surface portion 84a. The plurality of side wall portions 84b occupy about 180 degrees in total, of the 360-degree peripheral edge of the upper surface portion 84a while being slightly spaced apart from each other. Moreover, lower portions of the respective side wall portions 84b are configured so as to protrude slightly further inward, with respect to the radial direction, than corresponding upper portions thereof, and as a result, a step D3 is formed in the lower portions of the respective side wall portions 84b (see FIG. 16). When the bottle stopper 22 of the drug container 2 is slidingly inserted into the space in the bottle stopper accommodating portion 84 from a lateral side where the side wall portions 84b are not present, the step D3 engages with the step that is formed between the bottle stopper 22 and the neck portion 212 of the drug container 2 (see FIG. 17). Thus, the drug container 2 is supported by the bottle stopper accommodating portion 84 in a suspended manner. Moreover, since the side wall portions 84b are constituted by a plurality of members, the side wall portions 84b can deform so as to slightly widen outward with respect to the radial direction due to the elasticity of the resin material forming the side wall portions 84b, and the bottle stopper 22 of the drug container 2 can be easily inserted into the space in the bottle stopper accommodating portion 84.

A through hole H6 (first opening) for the needle 33 of the syringe 3 to pass therethrough is formed in the center of the upper surface portion 84a of the bottle stopper accommodating portion 84. Also, the bottom surface of the above-described elastic sealing member 66 and the cylindrical tubular member 62 that protects the elastic sealing member 66 are in contact with and fixed to the upper surface portion 84a. Accordingly, the through hole H6 is air-tightly blocked by the elastic sealing member 66 without any gap. It should be noted that the upper surface portion 84a and the elastic sealing member 66 are coaxially arranged.

Moreover, as shown in FIGS. 14 to 16, a plurality of (two, in the present embodiment) ribs 85 (protruding portions) are formed on a lower surface of the upper surface portion 84a of the bottle stopper accommodating portion 84. Even when the bottle stopper 22 of the drug container 2 moves in the top-bottom direction within the space in the bottle stopper accommodating portion 84, these ribs 85 keep a certain distance between the top surface of the bottle stopper 22 and the lower surface (first opposing surface) of the upper surface portion 84a of the bottle stopper accommodating portion 84 that opposes this top surface. As a result, a space S4 for accommodating the drug that has leaked from the drug container 2 is secured between the top surface of the bottle stopper 22 and the elastic sealing member 66 (see FIG. 17). Therefore, the space S4 that is capable of accommodating the drug leaking from the drug container 2 can be secured with a simple structure.

3-2. Method for Sucking Drug/Method for Mixing Drug

The following is a description of a method for sucking a drug according to the third embodiment, focusing on differences from the first and second embodiments. First, the user opens the zipper lock 81a of the bag 81 and inserts the drug container 2 into the bag 81 through the thus formed opening. Then, the user hooks the bottle stopper 22 of the drug container 2 to the step D3 of the bottle stopper accommodating portion 84. It should be noted that at this time, if the size of the bottle stopper accommodating portion 84 is designed so as to match the shape of the bottle stopper 22 of the drug container 2, the drug container 2 is tightly fixed by the bottle stopper accommodating portion 63. After that, the user closes the zipper lock 81a while roughly letting the air out of the bag 81. Thus, the drug container 2 is accommodated in the bag 81 in an air-tight state. In the same manner, the user prepares a plurality of drug container storage devices 8 in which the same drug or different drugs are contained. The operations after this process are the same as those of the first and second embodiments, and descriptions thereof are omitted.

3-3. Features

As described above, also in the third embodiment, the drug container 2 can be accommodated in the closed space that is hermetically sealed, and furthermore, the drug container 2 is accommodated in the bag 81 such that the space S4 is formed between the bottle stopper 22 of the drug container 2 and the elastic sealing member 66 that hermetically seals the through hole H6 of the bottle stopper accommodating portion 84. Therefore, during withdrawal of the needle 33 of the syringe 3 after passing the needle 33 through the elastic sealing member 66 and the bottle stopper 22 and sucking the drug into the syringe 3, even if the drug leaks from the drug container 2, the drug that has leaked remains in the space S4 between the bottle stopper 22 and the elastic sealing member 66, so that the drug can be confined in the closed space. As a result, during sucking of the drug into the syringe 3, exposure of the drug can be prevented from extending to the outside of the elastic sealing member 66. Also, since the drug container 2 is hermetically sealed in the drug container storage device 8, the drug container 2 can be disposed without exposing the drug to the outside by simply disposing of the drug container storage device 8 as is.

### 4. Modifications

Although some embodiments of the present invention have been described above, the present invention is not limited to the foregoing embodiments, and may be modified in various manners within the gist of the present invention. Moreover, the essential points of modifications that are described below may be combined as appropriate.

4-1

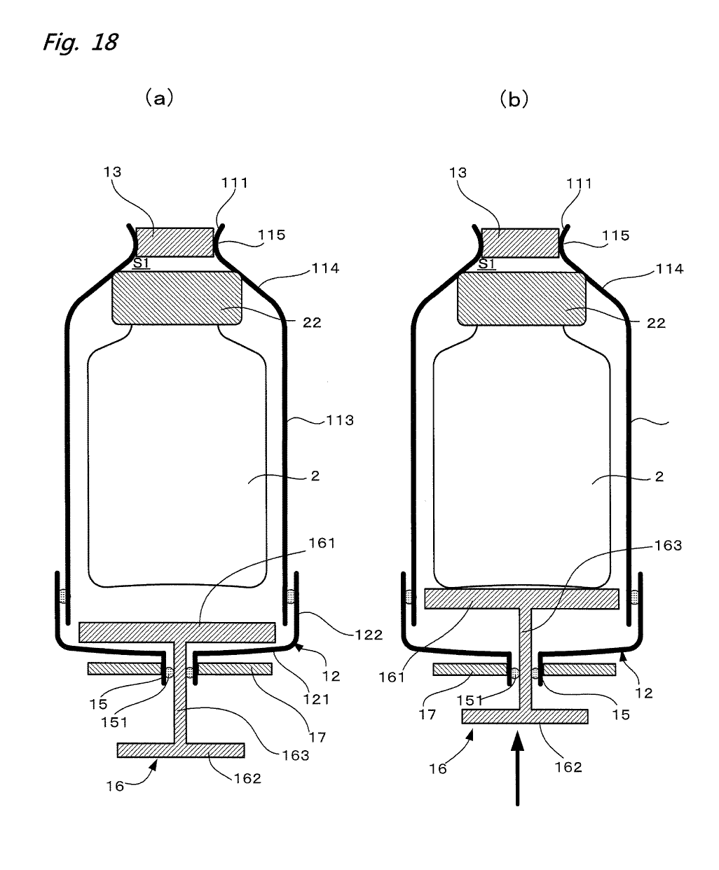

Although the second opening 112 is hermetically sealed by the lid member 12 and the valve mechanism 14 in the first embodiment, the following configuration may also be adopted. For example, as shown in FIG. 18(a), the lid member 12 is provided with a cylindrical tube portion 15 protruding outward, and is configured such that the inside and the outside of the main body portion 11 communicate with each other via the cylindrical tube portion 15. In addition, an adjuster 16 that presses the drug container 2 is attached to this cylindrical tube portion 15. The adjuster 16 is constituted by a disc-shaped pressing portion 161 that presses the bottom surface of the drug container 2 inside the main body portion 11, a disc-shaped operating portion 162 that is disposed outside the main body portion 11, and a connecting rod 163 that connects the pressing portion 161 and the operating portion 162 to each other. The connecting rod 163 is inserted into the cylindrical tube portion 15, and a gap between the cylindrical tube portion 15 and the connecting rod 163 is hermetically sealed by an O-ring 151 provided on an inner wall surface of the cylindrical tube portion 15. Moreover, a screw plate 17 is attached to the cylindrical tube portion 15 of the lid member 12, and when the screw plate 17 is tightened, the cylindrical tube portion 15 is tightened inward with respect to the radial direction, and thus the connecting rod 163 is fixed to the cylindrical tube portion 15. Thus, the position of the adjuster 16 can be fixed. It goes without saying that similarly to the foregoing embodiments, the air-tightness can be increased by placing an O-ring etc. between the lid member 12 and the main body portion 11 as necessary.

With the above-described mechanism, as shown in FIG. 18(b), after the drug container 2 is inserted into the main body portion 11, the lid member 12 is closed. Subsequently, the operating portion 162 of the adjuster 16 is pushed inward to press the drug container 2 toward the side of the first opening 111. Thus, the bottle stopper 22 of the drug container 2 abuts against the sloped surface of the main body portion 11, and the drug container 2 is positioned inside the main body portion 11. Subsequently, when the screw plate 17 is rotated, the cylindrical tube portion 15 is tightened, and the adjuster 16 is fixed. Thus, the position of the drug container 2 is fixed. It should be noted that in the second embodiment, it is also possible that the drug container 2 is fixed in the drug container storage device 6 by providing the adjuster 16 as described above in the bottom surface portion 72 of the main body lower portion 70.

4-2

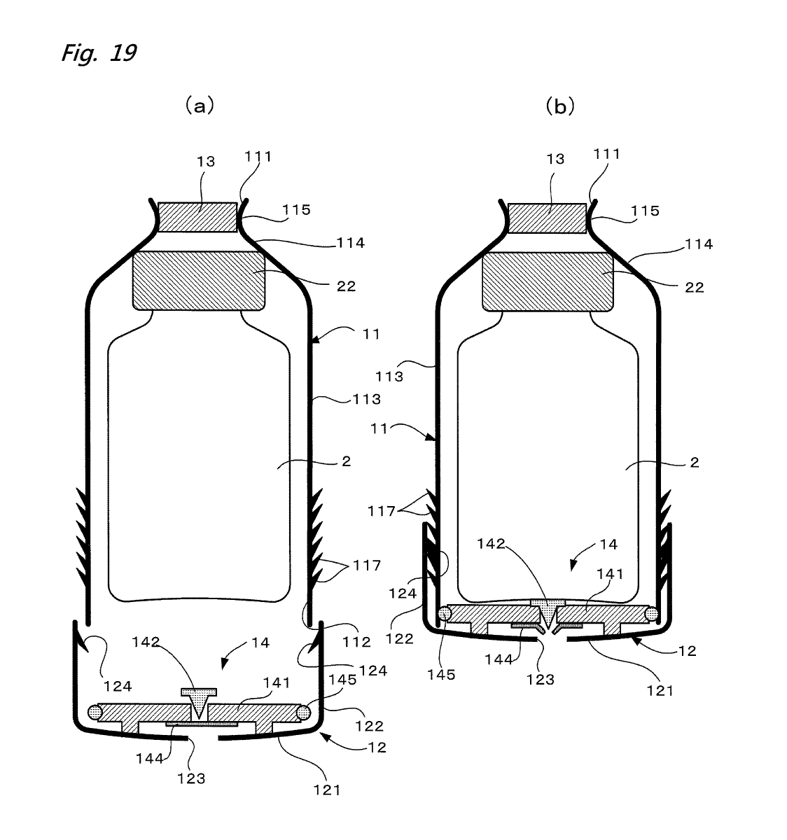

In the first embodiment, there is no limitation on the configuration for attaching the lid member 12 to the main body portion 11. For example, as shown in FIG. 19, while a first projection 124 is formed on an inner wall surface of the wall portion 122 of the lid member 12, a plurality of second projections 117 that are engageable with the first projection 124 are formed along the outer circumferential surface of the main body portion 11. The second projections 117 are formed annularly and arranged at regular intervals in an axial direction of the outer circumferential surface. Also, the second projections 117 are formed so as to be sloped toward the first opening 111 in order to prevent the lid member 12 from opening. Thus, the second projections 117 serve as a safety lock and are configured so as to prevent the first projection 124 from disengaging from the second projections 117 toward the second opening 112. Moreover, an O-ring 145 is attached to a peripheral edge of the base plate 141 of the valve mechanism 14 so that this O-ring 145 closely adheres to the inner wall surface of the second opening 112. This configuration also makes it possible to hermetically seal the main body portion 11 by attaching the lid member 12 to the second opening 112 and furthermore to reliably prevent disengagement of the lid member 12 when once the lid member 12 is attached. It should be noted that if the first projection 124 is formed over the entire circumference of the inner wall surface of the wall portion 122 of the lid member 12, it is easy to establish engagement with the second projections 117. It should be noted that the essential points of the present modification are applicable not only to the first embodiment but also to a case where the main body lower portion 70 is attached to the main body upper portion 60 in the second embodiment.

4-3

In the first embodiment, the lid member 12 may have a configuration other than that described above, and any configuration that can hermetically seal at least the second opening 112 may be adopted. Accordingly, it is also possible to provide no valve mechanism 14 and use the lid member 12 without the air hole 123 as the closing portion of the present invention. Moreover, it is also possible to provide a separate fixing mechanism that fixes the drug container 2 in the main body portion 11 and fix the drug container 2 in the main body portion 11 independently from the lid member 12. For example, a mechanism that sandwiches or circumferentially presses the drug container 2 can be used as the fixing mechanism. It should be noted that the essential points of the present modification are applicable not only to the first embodiment but also to the second embodiment. In the second embodiment, the valve element 68 and the communication passage forming member 67 may be omitted, and a separate fixing mechanism may also be provided.

4-4

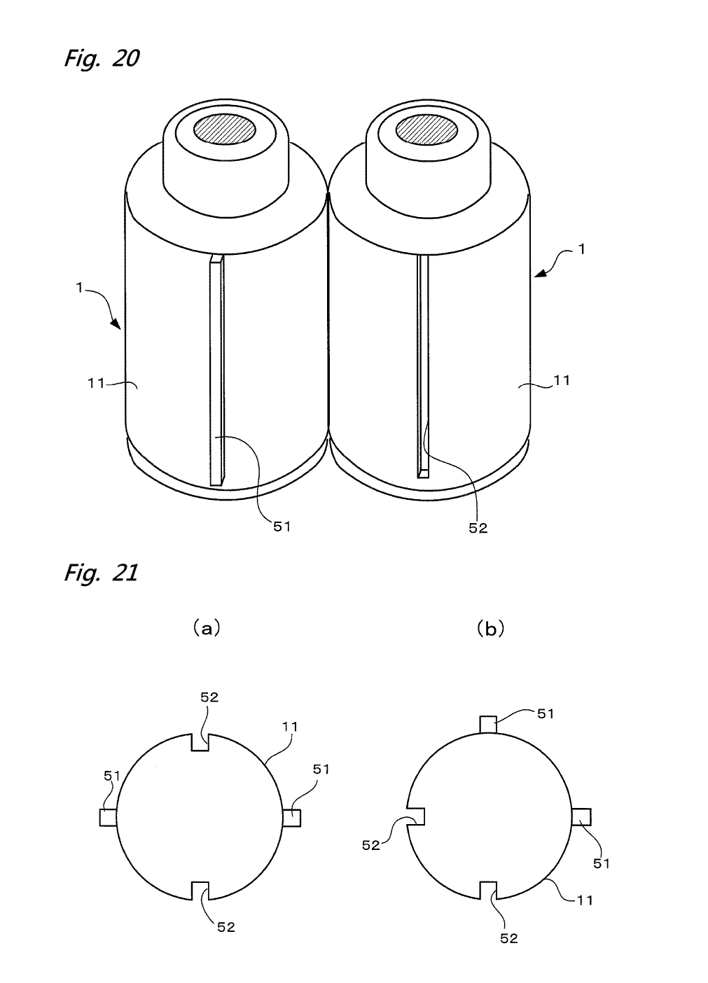

Although the plurality of drug container storage devices 1 are separately prepared in the first embodiment, as shown in FIG. 20, a drug container storage system in which the plurality of drug container storage devices 1 are connected may also be used. In this system, protruding portions 51 and recessed portions 52 extending in the axial direction are provided on the outer circumferential surface of each drug container storage device 1, that is, the outer circumferential surface of the main body portion at intervals of 90 degrees, and the devices 1 are connected by bringing the protruding portions 51 and the recessed portions 52 into engagement. There is no particular limitation on the positions at which the protruding portions 51 and the recessed portions 52 are provided. For example, as shown in FIG. 21(a), it is possible to arrange a pair of protruding portions 51 and a pair of recessed portions 52 on the outer circumferential surface of the main body portion 11 such that the protruding portions 51 oppose each other and the recessed portions 52 oppose each other. That is to say, the protruding portions 51 and the recessed portions 52 are alternately formed at intervals of 90 degrees. Alternatively, as shown in FIG. 21(b), it is possible to form a pair of protruding portions 51 and a pair of recessed portions 52 on the outer circumferential surface of the main body portion 11 such that the protruding portions 51 are adjacent to each other and the recessed portions 52 are adjacent to each other in the circumferential direction. A plurality of drug container storage devices 1 in which the protruding portions 51 and the recessed portions 52 are formed as described above are prepared, and the plurality of drug container storage devices 1 are unified by bringing the protruding portions 51 and the recessed portions 52 into engagement. Thus, an operation of dissolving by collectively shaking a plurality of drug containers is made possible. Moreover, during sucking of the drug using the syringe 3, since all of the drug containers 2 are arranged close to each other, sucking of a plurality of drugs is easy, so that operability is improved. It should be noted that the protruding portions 51 and the recessed portions 52 are not necessarily required to be formed at intervals of 90 degrees, and it is sufficient if adjacent drug container storage devices 1 can be connected to each other. Moreover, the connecting method is not limited to the formation of the protruding portions 51 and the recessed portions 52. It is sufficient if the drug container storage devices 1 can be connected such that the elastic sealing members 13 face in the same direction, and various other known methods including a method that uses a hook-and-loop fastener or the like may be applied. It should be noted that the essential points of the present modification are applicable not only to the first embodiment but also to the second embodiment, and a configuration is also possible in which a plurality of drug container storage devices 6 are connectable in the same manner.

4-5

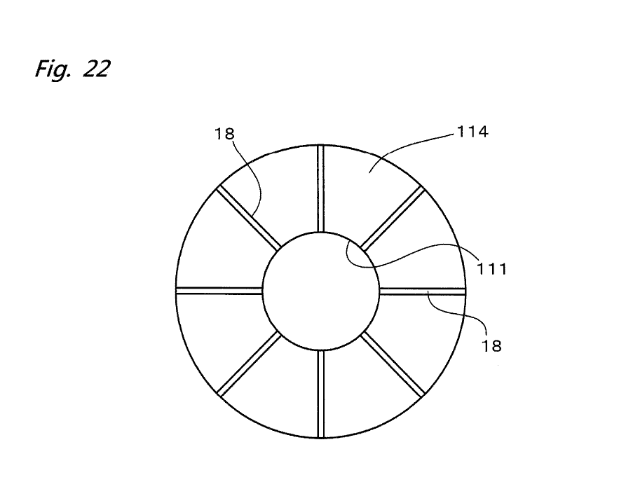

In the first embodiment, as shown in FIG. 22, a plurality of ribs or grooves 18 extending in the axial direction can be provided on the sloped surface of the shoulder portion 114 of the main body portion 11. Thus, the drug leaking into the space S between the bottle stopper 22 and the elastic sealing member 13 can be caused to move along the grooves or ribs 18 to the side of the drum portion 113. Accordingly, the drug leaking from the drug container 2 can be caused to move away from the first opening 111, so that leakage of the drug through the first opening 111 can be reliably prevented. In particular, in cases where a large amount of drug has leaked from the drug container, this plays a significant role in preventing exposure of the drug because the drug is likely to flow along the grooves or ribs 18.

4-6

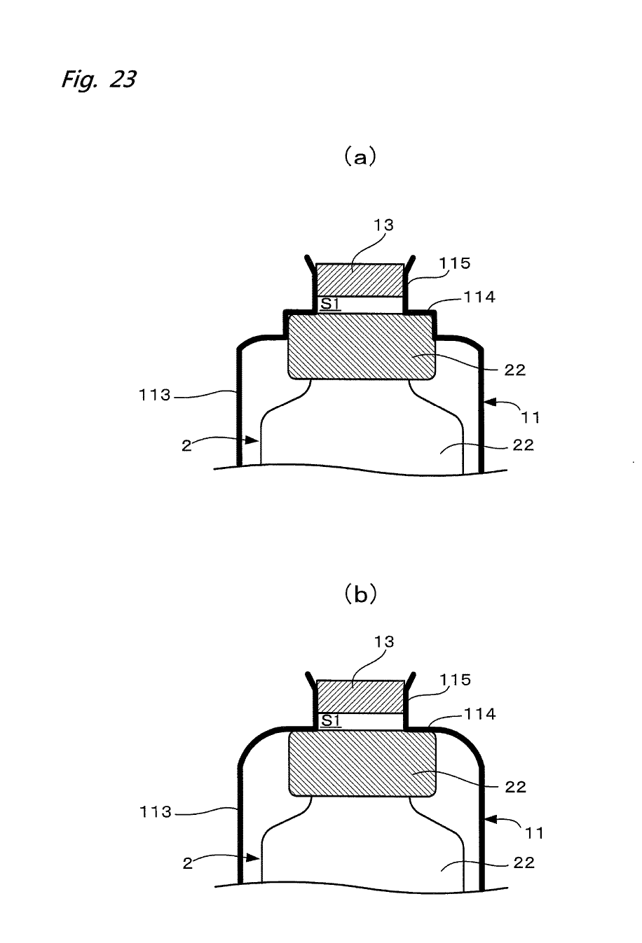

In the first embodiment, the bottle stopper 22 of the drug container 2 comes into contact with the sloped surface of the shoulder portion 114 of the main body portion 11. However, the mode of this contact is not particularly limited as long as the space S is formed between the bottle stopper 22 and the elastic sealing member 13. For example, as shown in FIG. 23(a), it is also possible that a step is provided in the shoulder portion 114, and the bottle stopper 22 is fitted in this step. Moreover, as shown in FIG. 23(b), it is also possible that the shoulder portion 114 is flat, and the bottle stopper 22 comes into contact with this shoulder portion 114. In this case, the internal space of the neck portion 115 serves as the above-described space S.

4-7

In the first embodiment, the elastic sealing member 13, which is provided in the drug container storage device 1, is directly fitted into the first opening 111. However, the mode of the elastic sealing member 13 is not particularly limited as long as the elastic sealing member 13 is configured so as to close the first opening 111 and allow the needle (passage portion) of the syringe to be stabbed therein. For example, the elastic sealing member 13 may be configured similarly to the bottle stopper 22 of the drug container 2.

4-8

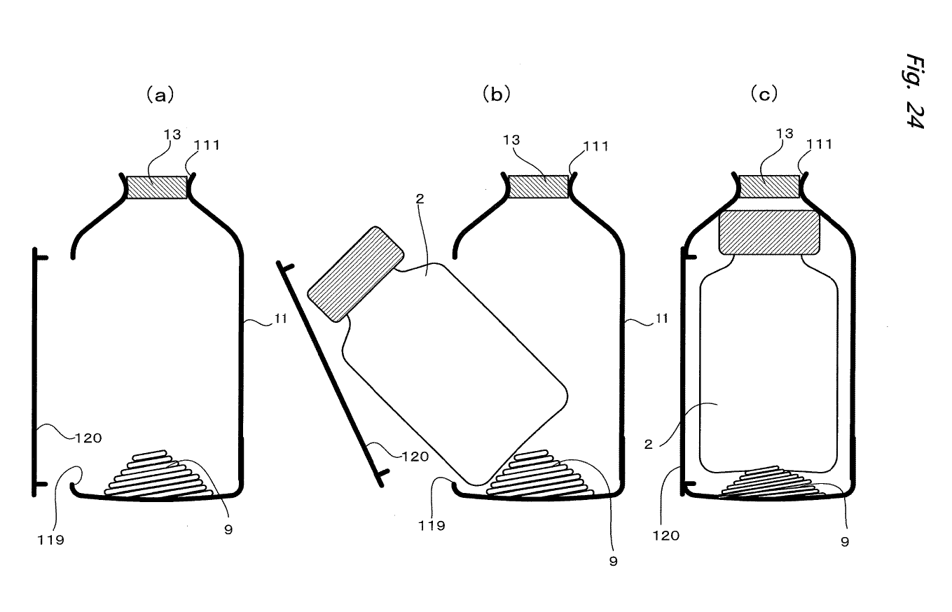

In the first embodiment, the main body portion is provided with the second opening, through which the drug container is accommodated. However, there is no particular limitation on the method by which the drug container is accommodated. For example, as shown in FIG. 24, an opening 119 is formed in the outer circumferential surface of the main body portion 11, and a lid member 120 that air-tightly blocks this opening 119 is provided. Moreover, a spring 9 is provided on a bottom surface, that is, the surface opposing the first opening 111, of the main body portion 11 and is configured such that the spring 9 presses the drug container accommodated in the main body portion toward the first opening and thus brings the bottle stopper of the drug container into contact with the shoulder portion of the main body portion. This configuration also makes it possible to hermetically seal the drug container in the state in which the above-described space S is formed as well. It should be noted that the essential points of the present modification with regard to the position of the second opening are also applicable to the second embodiment and the third embodiment as well.

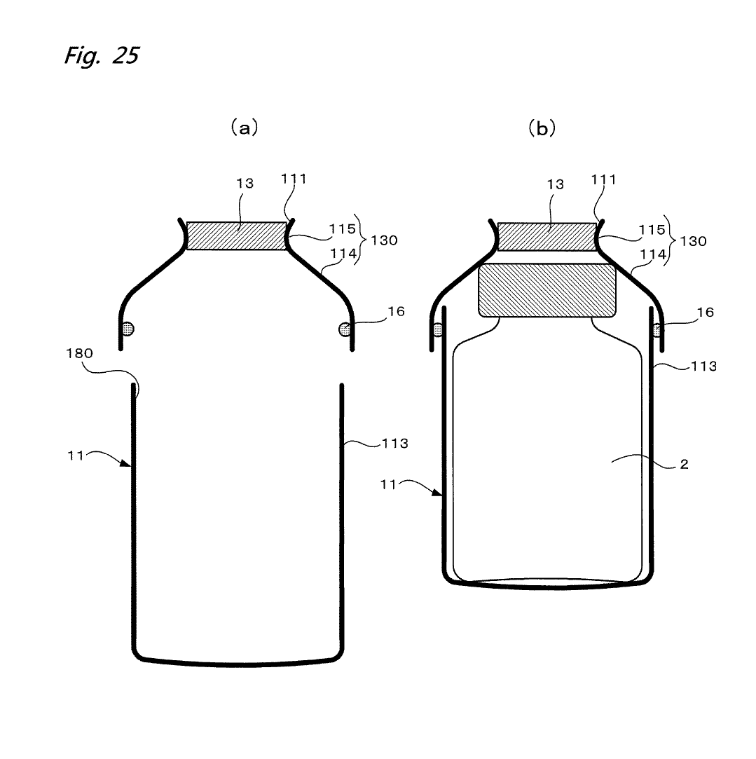

Alternatively, as shown in FIG. 25, it is also possible that a lid member 130 into which the shoulder portion 114 and the neck portion 115, of the main body portion 11, including the first opening 111 are integrated is formed, and an opening 180 that is formed in the drum portion 113 of the main body portion 11 is blocked by this lid member 130.

4-9

In the second embodiment, the number of ribs 69a and 69b is not limited to those described above, and may also be one to five, or seven or more. Moreover, it is not necessarily required that the number of ribs 69a and the number of ribs 69b are equal to each other. The same applies to the number of ribs 85 of the third embodiment.

4-10

In the second embodiment, the shapes of the protruding portions that prevent the bottle stopper 22 of the drug container 2 from coming into contact with the drug container storage device 6 are not limited to the shapes of the above-described ribs 69a and 69b. For example, the protruding portions may be simply dot-shaped. The same applies to the shape of the ribs 85 of the third embodiment.

4-11

In the example of the above-described drug container storage device 6, the positions at which the protruding portions that prevent the bottle stopper 22 of the drug container 2 from coming into contact with the drug container storage device are formed are preferably on the lower surface of the upper surface portion 63b and the inner circumferential surface of the side surface portion 63a, of the bottle stopper accommodating portion 63 of the main body upper portion 60. However, with other configurations of the drug container storage device, the protruding portions can be formed at other positions. For example, in the example of the drug container storage device 1 of the first embodiment, the protruding portions may be formed on an opposing surface of the elastic sealing member 13 that opposes the top surface of the bottle stopper 22 of the drug container 2. That is to say, such protruding portions may be formed in the elastic sealing portion instead of the main body portion of the drug container storage device or may be formed in both of the main body portion and the elastic sealing portion, as long as the protruding portions act to prevent the bottle stopper 22 of the drug container 2 from coming into contact with the drug container storage device.

4-12

In the second embodiment, instead of or in addition to the above-described ribs 69b, grooves may be formed. In this case, the drug dropping into the space S2 between the top surface of the bottle stopper 22 of the drug container 2 and the elastic sealing member 66 can be guided to a lower space via the space S3 as well.

4-13

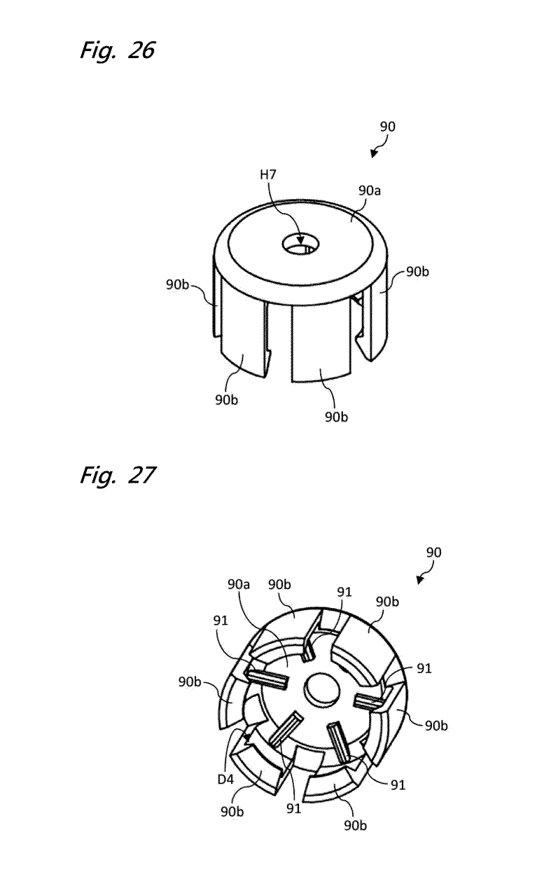

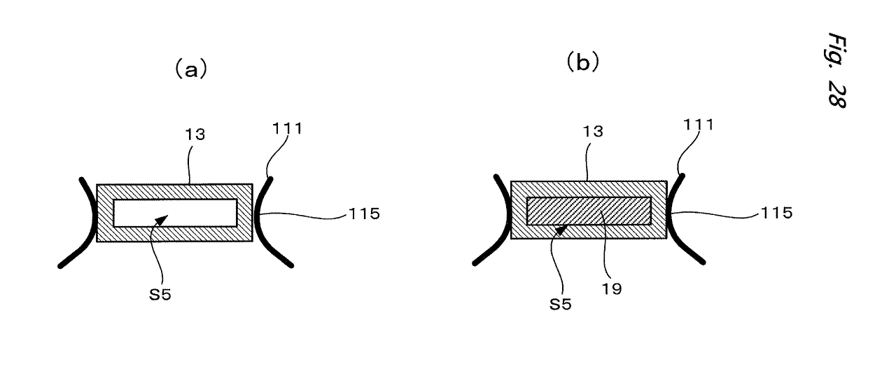

The bottle stopper accommodating portion 84 of the third embodiment may be replaced with a bottle stopper accommodating portion 90 as shown in FIGS. 26 and 27. That is to say, this bottle stopper accommodating portion 90 has a generally disc-shaped upper surface portion 90a and a plurality of (six, in the present embodiment) side wall portions 90b extending downward from a peripheral edge of this upper surface portion 90a. In addition, similarly to the third embodiment, a through hole H7 (first opening) for the needle 33 of the syringe 3 to pass therethrough is formed in the center of the upper surface portion 90a. Moreover, the plurality of side wall portions 90b are arranged at regular intervals along the 360-degree peripheral edge of the upper surface portion 90a while being slightly spaced apart from each other. Here also, a step D4 corresponding to the step D3 of the third embodiment is present in lower portions of the respective side wall portions 90b, and thus the drug container 2 can be supported by the bottle stopper accommodating portion 90 in a suspended manner. However, since the side wall portions 90b are distributed around the entire 360-degree circumference of the upper surface portion 90a, the bottle stopper 22 cannot be slidingly inserted into the space in the bottle stopper accommodating portion 90 from a lateral side. Thus, in this modification, the bottle stopper 22 is inserted from below the bottle stopper accommodating portion 90. At this time, the side wall portions 90b are constituted by a plurality of members, and thus can deform so as to slightly widen outward, with respect to the radial direction, due to the elasticity of the resin material forming the side wall portions 90b, so that the bottle stopper 22 can be readily inserted into the space in the bottle stopper accommodating portion 90. With the above-described configuration, once the drug container 2 is supported by the bottle stopper accommodating portion 90, the drug container 2 is prevented from laterally coming off the bottle stopper accommodating portion 90 and is thus more firmly supported. Moreover, also in this modification, it is preferable that a plurality of ribs 91 corresponding to the ribs 85 of the third embodiment are formed on a lower surface of the upper surface portion 90a to secure the space S4 that is capable of accommodating the drug leaking from the drug container 2, between the bottle stopper 22 and the elastic sealing member 66. It should be noted that in this modification, the ribs 91 are radially arranged around the through hole H7.

4-14

In the first embodiment, a hollow member can be used as the elastic sealing member 13 as shown in FIG. 28(a), and furthermore, a water-absorbing material 19 can be filled into an internal space S5 of the hollow member as shown in FIG. 28(b). In this case, during withdrawal of the needle 33 from the elastic sealing member 13, even if a minute amount of drug adheres to the needle 33 and attempts to escape to the outside, the drug can be kept in the above-described space S5 or retained by the water-absorbing material 19. Therefore, according to the present modification, leakage of the drug to the outside can be more reliably prevented. It should be noted that the present modification is also applicable to the elastic sealing member 66 of the second and third embodiments, and also in this case, during withdrawal of the needle 33 from the elastic sealing member 66, leakage of the drug to the outside can be more reliably prevented.

1. A drug container storage device used for performing sucking of a drug contained in a drug container using a syringe, the syringe having a passage portion through which a liquid is sucked in and discharged, and the drug container having a lid portion that can be penetrated by the passage portion, the drug container storage device comprising:
a main body portion including a closed space configured to accommodate the drug container and a first opening; and
an elastic sealing portion configured to hermetically seal the first opening of the main body portion and that can be penetrated by the passage portion of the syringe,
wherein the main body portion is configured to accommodate the drug container such that a space is formed between the lid portion of the accommodated drug container and the elastic sealing portion.

2. The drug container storage device according to claim 1,
wherein the main body portion includes a second opening through which the drug container is accommodated and a closing portion configured to hermetically seal the second opening.

3. The drug container storage device according to claim 2,
wherein the first and second openings are formed opposing each other, and
the closing portion is configured so as to press the drug container toward the side of the first opening and fix the drug container in the main body portion.

4. The drug container storage device according to claim 1,
wherein on a first opposing surface, of at least one of the main body portion and the elastic sealing portion, that is configured to oppose a top surface of the lid portion of the drug container, a protruding portion configured to secure the space between the top surface of the lid portion and the elastic sealing portion is formed.

5. The drug container storage device according to claim 4,
wherein a protruding portion is formed on a second opposing surface, of at least one of the main body portion and the elastic sealing portion, that is configured to oppose a side surface of the lid portion of the drug container.

6. The drug container storage device according to claim 1,
wherein the main body portion is a deformable bag.

7. The drug container storage device according to claim 1,
wherein the main body portion includes:
a tubular drum portion having, at opposite end portions, a first end portion and a second end portion in which the second opening is formed;
a shoulder portion having a sloped surface that is sloped from the first end portion in a funnel shape; and
a neck portion that is continuous with the shoulder portion and in which the first opening is formed,
wherein the space is formed by bringing the lid portion of the drug container into contact with the sloped surface of the shoulder portion.

8. The drug container storage device according to claim 7,
wherein a plurality of grooves or ribs are formed on the sloped surface, the grooves or ribs extending from the first opening toward the drum portion.

9. The drug container storage device according to claim 2,
wherein a through hole is formed in the closing portion, and a valve member that is inserted into the through hole is provided, and
the valve member is configured such that when the second opening is hermetically sealed by the closing portion, the valve member is configured to close the through hole and protrude from the through hole.

10. The drug container storage device according to claim 1,
wherein the elastic sealing portion is configured to be fitted into the first opening by being compressed in a radial direction.

11. A drug container storage system comprising:
a plurality of drug container storage devices according to claim 1; and
a connecting mechanism configured to connect the plurality of drug container storage devices such that the first openings face in the same direction.

12. The drug container storage system according to claim 11,
wherein at least one protruding portion and at least one recessed portion are formed on an outer circumferential surface of the main body portion, the protruding portion and the recessed portion extending in an axial direction, and
the connecting mechanism is configured by the protruding portion and the recessed portion and is configured to connect the drug container storage devices by establishing engagement between the recessed portion and the protruding portion.

13. A method for sucking a drug, comprising:
preparing a syringe having a passage portion though which a liquid is sucked in and discharged;
preparing at least one drug container having a lid portion into which the passage portion can be stabbed and containing a drug;
preparing at least one drug container storage device having a closed space configured to accommodate the drug container, a first opening, and an elastic sealing portion configured to be attached to the first opening and into which the passage portion of the syringe can be stabbed;
causing the drug container to be accommodated in the drug container storage device such that a space is formed between the lid portion of the drug container and the elastic sealing portion;
stabbing the passage portion of the syringe into the elastic sealing portion and the lid portion;
sucking the drug in the drug container into the syringe; and
withdrawing the passage portion of the syringe from the elastic sealing portion and the lid portion.

14. The method for sucking a drug according to claim 13,
wherein the drug is in powder form,
the method further comprising:
producing a drug in liquid form by injecting a mixing solution contained in the syringe into the drug container, prior to sucking the drug,
wherein in sucking the drug in the drug container into the syringe, the drug in liquid form is sucked.

15. A method for sucking a drug,
wherein the method for sucking a drug according to claim 13 is repeated a plurality of times with respect to a plurality of different said drugs to suck the plurality of drugs into one syringe as defined above.
